(19) United States
(12) Patent Application Publication
(10) Pub. No.: US 2016/0102995 A1
(43) Pub. Date: Apr. 14, 2016

(54) OPPORTUNISTIC CALIBRATION OF A BAROMETER IN A MOBILE DEVICE

(71) Applicant: QUALCOMM Incorporated, San Diego, CA (US)

(72) Inventors: Arnold Gum, San Diego, CA (US); Mark Leo Moeglein, Ashford, OR (US)

(21) Appl. No.: 14/879,017

(22) Filed: Oct. 8, 2015

Related U.S. Application Data
(60) Provisional application No. 62/062,621, filed on Oct. 10, 2014.
(60) Provisional application No. 62/120,864, filed on Feb. 25, 2015.
(60) Provisional application No. 62/121,480, filed on Feb. 26, 2015.

(51) Int. Cl. G01C 25/00; G01C 5/06

(52) U.S. Cl. CPC G01C 25/00; G01C 5/06

(57) ABSTRACT

Disclosed are systems, methods and techniques for calibrating a barometric pressure sensor of a mobile device. In one embodiment, a barometric pressure sensor of a mobile device may be calibrated by determining that a location of the mobile device is on a particular discrete vertical of a plurality of discrete vertical levels.

This patent application claims benefit of and priority to co-pending U.S. Provisional Patent Application Nos. 62/062,621, filed Oct. 10, 2014, titled “OPPORTUNISTIC CALIBRATION OF A BAROMETER IN A MOBILE DEVICE,” 62/120,864, filed Feb. 25, 2015, titled “OPPORTUNISTIC CALIBRATION OF A BAROMETER IN A MOBILE DEVICE,” and 62/121,480, filed Feb. 26, 2015, titled “OPPORTUNISTIC CALIBRATION OF A BAROMETER IN A MOBILE DEVICE,” both of which are assigned to the assignee hereof and incorporated herein in their entirety by reference.

### BACKGROUND

1. Field

The subject matter disclosed herein relates to electronic devices, and more particularly to methods, apparatuses and articles of manufacture for use in a mobile device having a barometer.

2. Information

As its name implies, a mobile device may be moved about, e.g. typically being carried by a user and/or possibly a machine. By way of some non-limiting examples, a mobile device may take the form of a cellular telephone, a smart phone, a tablet computer, a laptop computer, a wearable computer, a navigation and/or tracking device, etc.

In certain instances, particularly with indoor navigation applications, it may be useful to determine an altitude level of a mobile device. This may be particularly useful in navigating multi-story environments in which a mobile device may be provided with navigation assistance data such as locations of transmitters, radio heatmaps, digital maps for display, routing maps, etc.

A mobile device may be determined to be located on a particular floor of a building using one or more wireless signal-based positioning techniques. In particular scenarios, it may be desirable to provide estimated locations of a mobile device to include an altitude level component. In a dense urban environment including multistory skyscrapers, for example, merely providing longitude and latitude components for a location in the absence of an altitude level component may be of limited utility for some services (e.g., emergency 911 services).

While obtaining a position fix from acquisition of satellite positioning system (SPS) signals in a rural or single-story suburban environment may provide an altitude level component of sufficient accuracy for most services, an SPS or other like signal-based position fix may not provide an altitude level component with sufficient accuracy or precision.

In certain implementations, a network carrier may populate a dense urban environment with low-power beacon transmitters and/or femtocells to assist subscriber mobile devices in accurately resolving an altitude level component of locations of the mobile devices. Such a deployment of low power beacon transmitters and/or femtocells may, however, prove too costly and/or provide for limited/sporadic coverage.

In another particular implementation, a mobile device may resolve an altitude level component of its location (e.g., as being on a particular floor of a building) by obtaining atmospheric pressure measurements using an onboard barometer and comparing such to a reference atmospheric pressure. However, atmospheric pressure tends to change overtime, and hence a reference atmospheric pressure (local to the mobile device) may need to be updated frequently. Rather than relying on other devices to provide reference atmospheric pressure updates, it may be useful for a mobile device to determine a reference atmospheric pressure on its own, for example, through one or more barometer calibration processes which may identify a reference atmospheric pressure corresponding to a particular altitude level.

### SUMMARY

Briefly, one particular implementation is directed to a method comprising, method, at a mobile device, comprising: determining that the mobile device is located at a frequently visited location and that an onboard barometric pressure sensor is in a calibrated state; determining that the mobile device is located on a particular discrete vertical level of a plurality of discrete vertical levels at the frequently visited location; determining an altitude value based, at least in part, one or more signals from the onboard barometric pressure sensor; and storing the determined altitude value in association with the particular discrete vertical level, the frequently visited location, or both.

Another particular implementation is directed to a mobile device comprising: an onboard barometric pressure sensor; a memory device; and a processing unit configured to: determine that the mobile device is located at a frequently visited location and that the onboard barometric pressure sensor is in a calibrated state; determine that the mobile device is further located on a particular discrete vertical level of a plurality of discrete vertical levels at the frequently visited location; determine an altitude value based, at least in part, one or more signals from the onboard barometric pressure sensor; and store the determined altitude value in the memory device in association with the particular discrete vertical level, the frequently visited location, or both.

Another particular implementation is directed to a method at a mobile device comprising: determining that the mobile device is located on a discrete vertical level at a frequently visited location; obtaining one or more barometric pressure measurements from an onboard barometric pressure sensor; selecting a discrete level from among a plurality of discrete vertical levels identified in a memory device based at least in part on the obtained one or more barometric pressure measurements; and aligning the obtained one or more barometric pressure measurements with an altitude value stored in the memory device corresponding to the selected discrete vertical level to calibrate the onboard barometric pressure sensor.

Another particular implementation is directed to a mobile device comprising: an onboard barometric pressure sensor a memory device; and a processing unit configured to: determine that the mobile device is located on a discrete vertical level at a frequently visited location; obtain one or more barometric pressure measurements from the onboard barometric pressure sensor; select a discrete level from among a plurality of discrete vertical levels identified in the memory device based at least in part on the obtained one or more barometric pressure measurements; and align the obtained one or more barometric pressure measurements with an altitude value stored in the memory device corresponding to the selected discrete vertical level to calibrate the onboard barometric pressure sensor.

It should be understood that the aforementioned implementations are merely example implementations, and that claimed subject matter is not necessarily limited to any particular aspect of these example implementations.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an arrangement of representative electronic devices including a mobile device comprising an apparatus for opportunistically calibrating a barometer onboard the mobile device, in accordance with an example implementation.

FIG. 2 is an illustrative diagram representing certain example structural and natural features of an environment wherein a mobile device, for example, as in FIG. 1, may be transported about by a person, and wherein in certain instances a barometer onboard the mobile device may be opportunistically calibrated, in accordance with certain example implementations.

FIG. 3A and FIG. 3B are flow diagrams illustrating some example processes that may be implemented using a mobile device, for example, as in FIG. 1, to opportunistically calibrate a barometer onboard the mobile device, in accordance with certain example implementations.

FIG. 3C is an illustrative diagram showing certain features of the interior of a multistory building according to an embodiment.

FIG. 3D is a flow diagram of a process to calibrate measurements obtained at an altimeter of a mobile device according to an embodiment.

FIG. 3E is a flow diagram of a process to calibrate measurements obtained at an altimeter of a mobile device according to an alternative implementation.

FIG. 3F is a flow diagram of a process for obtaining measurements of altitudes for discrete vertical levels, according to an embodiment.

FIG. 3G is a flow diagram of a process that may be used for calibrating a barometric pressure sensor, according to an embodiment.

FIG. 4 is a schematic diagram illustrating certain features of an example special purpose computing platform that may be provisioned within a mobile device, for example, as in FIG. 1, and which may benefit from the techniques for opportunistic barometer calibration, for example, as in FIGS. 3A, 3B, 3D, 3E, 3F and 3G in accordance with certain example implementations.

### DETAILED DESCRIPTION

Various techniques are described herein which may be implemented in a mobile device to initiate one or more calibration processes corresponding to a barometer onboard a mobile device under certain circumstances/conditions. As mentioned, it may be useful to calibrate a barometer onboard a mobile device from time to time since atmospheric pressure often changes with over time due to various weather-related phenomena. Further, in certain instances, it may be useful for a mobile device to determine a reference atmospheric pressure corresponding to a particular altitude. For example, with knowledge of such a reference atmospheric pressure and corresponding altitude, it may be possible to estimate an altitude of the barometer (and hence, mobile device) by accounting for the known relationship between altitude and atmospheric pressure.

In certain instances, a mobile device may be able to obtain an applicable reference atmospheric pressure for a particular altitude (e.g., via one or more messages from a network resource, a local weather service computer, etc.). However, in certain instances a mobile device may be unable to obtain such information. For example, a mobile device may be unable at times to send/receive messages. Furthermore, in certain instances, a process to obtain such information from time to time may consume precious resources (e.g., processing resources at the mobile device and/or other devices, communication bandwidth, power supply resources, memory resources, etc.). For these or other reasons, it may be useful for a mobile device to be able to perform one or more calibration processes, for example, to identify a reference atmospheric pressure for a particular altitude.

As described herein, certain techniques may be implemented in a manner that allows for calibration of a barometer onboard a mobile device at certain times, possibly more “opportunistic” times. For example, there may be times when a calibration of a barometer may be less desirable and hence more likely to fail or include too much uncertainty. One example is that calibrating a barometer while the mobile device is carried by a person riding in a moving elevator may be wasteful of resources. In another example, it may be wasteful of resources to perform a barometer calibration process without being able to estimate a likely current altitude (a discernable altitude level) of a mobile device.

However, as described herein, some detectable motions or types of motions (motion modes) of a mobile device may actually be indicative, at least in part, of a potential opportunity to initiate one or more barometer calibration processes. For example, there may be certain types of motion of a mobile device that may support an inference that the mobile device may be located at a discernable altitude level for an adequate period of time during which there may exist an opportunity to perform one or more barometer calibration processes. For example, it may prove beneficial to initiate a barometer calibration process in response to an estimation that a mobile device may be located at a discernible altitude level. By way of some initial non-limiting examples, there may be an opportunity to initiate a barometer calibration process while a person may be walking along a sidewalk of a portion of a street that may be at a discernable (ground) level within a city, or perhaps riding in a car, bus or train on a roadway or railway at a discernable (ground) level, or perhaps at an elevated level (e.g., a bridge, an highway, etc.), or conversely at a lowered level (e.g., a tunnel, an underpass, etc.). Of course, it may be useful for such motion to occur or remain within a discernible altitude level during the calibration process(es).

Several techniques are provided by way of various examples herein that may be used to estimate, at least in part, whether a mobile device may be, or have been, in a qualifying motion at a discernable altitude level to possibly trigger (initiate) one or more barometer calibration processes. It should be understood, however, that the examples provided herein are not necessarily intended to limit claimed subject matter. Moreover, it should also be understood that there may be a variety of different known barometer calibration processes that may be performed and that claimed subject matter is not intended to necessarily be limited to any particular process. Indeed, since such processes are well known and may be particular to a given manufacture of barometer or type of barometer, no specific barometer calibration process will be described herein. As may be appreciated, however, an example barometer calibration process may provide a measured atmospheric pressure serving as, or otherwise support calculation of, a reference atmospheric pressure for a discernible altitude level.

With this in mind, in certain example implementations it may be estimated that a mobile device may be in a qualifying motion at a discernible altitude level based, at least in part, on one or more signals obtained from one or more sensors onboard the mobile device. Such sensor(s) may comprise, for example, one or more environmental sensors, such as, for example, a barometer, a magnetometer, a light sensor, a sound sensor, a thermometer, a proximity sensor, and/or the like or some combination thereof. Such sensor(s) may comprise, for example, one or more inertial sensors, such as, for example, an accelerometer, a gyroscope, and/or the like or some combination thereof.

Additionally, in certain example implementations, it may be estimated that a mobile device may be in a qualifying motion at a discernible altitude level based, at least in part, on an electronic map indicative of a local terrain (e.g., indicative of various altitudes, elevations, a topography, etc.). For example, an electronic map may be indicative of altitude(s) of a ground level of a local terrain, e.g., a street level, sidewalk level, etc. For example, an electronic map may be indicative of an altitude of a raised roadway or railway, or conversely a tunnel. For example, an electronic map may be indicative of a suspended pedestrian bridge or walkway between certain buildings/structures, possibly along with other information that may be useful in navigating between and/or within such building(s)/structure(s).

It should be noted that as used herein the term “altitude” may comprise a traditional altitude measurement, e.g., relating to a distance from a reference point/level such as a mean sea level, an Earth-centered coordinate system, etc., and may also or alternatively comprise other types of distance measurements such as a height, an elevation, an offset, etc., that may be relatable to or otherwise correspond to an altitude. Accordingly, as used herein, the phrase “altitude level” may be considered to represent a likely particular “altitude” (e.g., a given distance above sea level, a specific distance from the center of Earth, etc.), a likely range of altitudes (e.g., between two given distances from a reference point, or a particular altitude plus or minus some potential error distance (a measure of uncertainty in this example)), a quantifiable level of a structure (e.g., a floor level of a building, a deck of a bridge, etc.).

As mentioned, in response to an estimation that a mobile device is located at a discernible altitude level (e.g., a ground level, a bridge level, a tunnel level, a floor level, a particular altitude, etc.), one or more calibration processes corresponding to a barometer onboard the mobile device may be opportunistically initiated to identify a reference atmospheric pressure for the discernible altitude level. In one particular implementation, a mobile device may be determined to be located at a particular discernable altitude if the mobile device is determined to be in a particular qualifying motion, for example.

In certain example implementations, an estimation that a mobile device may be in a qualifying motion at a discernible altitude level may be based, at least in part, on an estimation that a trajectory of the mobile device is “level”. For example, an estimation that a trajectory of the mobile device is level may be based, at least in part, on a comparison of signals and/or measurements obtained from one or more of the sensors onboard the mobile device, and/or possibly with comparison to one or more applicable level trajectory threshold values. For example, a trajectory of a mobile device may be deemed level if a measured barometric pressure does not change more than some applicable level trajectory threshold amount over a period of time or at different times. For example, a trajectory of a mobile device may be deemed level if certain inertial sensor measurements remain below some applicable level trajectory threshold levels. For example, such one or more inertial sensors may indicate vertical motion of the mobile device in a direction of a gravity vector, the absence of which or less than some threshold level of which may support an inference of a level trajectory. Of course, these are just a few examples.

In certain example implementations, a trajectory of a mobile device may be estimated to be level based, at least in part, on an estimated velocity of the mobile device, and/or an estimated mode of transportation. For example, a trajectory may be level for a period of time while a person carrying the mobile device is walking, running, riding in a vehicle, etc., which may correspond to an estimated velocity and/or mode of transportation. Here, it may be further useful to consider applicable routes of travel, etc., as indicated may be indicated in an electronic map, along with information from a pedometer, a vehicle speedometer, or other like known function depending on the mode of transportation.

In certain example implementations, a mobile device may be estimated as in motion at a discernible altitude level, based, at least in part, on an estimated movement routine corresponding to the mobile device. Here, for example, a person carrying the mobile device may follow certain routines with regard to their movements. For example, a movement routine may comprise a period of commuting between a place of work and a home during certain times of a day on certain days of a week. Accordingly, during such movement routines, a person may be traveling in according to some more of transportation that may correspond to a level trajectory at times. In another example, a movement routine may be estimated based on a history and/or a schedule that may be identified as corresponding to the mobile device and/or person carrying the mobile device. For example, a person may walk along a sidewalk, ride a train, etc., to attend a lunch meeting, a doctor appointment, a golf tee-time, and/or the like, possibly according to common pattern or routine, and/or some schedule (e.g., possibly identifiable, at least in part, via a text message, a voice message, an electronic mail message, a calendar event, a timer, etc.).

In certain example implementations, a mobile device may be determined to be in a qualifying motion at a discernible altitude level, based, at least in part, on one or more wireless signals acquired from one or more transmitting devices. For example, motion of a mobile device may be indicated via various changes in a wireless signal from a terrestrial-based transmitting device that is not itself moving, e.g., there may be increase or decrease a received signal strength measurement as the mobile device moves closer or farther from a transmitting device, there may be frequency Doppler affect as the mobile device moves closer or farther from such a transmitting device, there may be a loss of signal, there may be a new signal, there may be a handoff of a mobile device from one serving transmitting device to another, etc., just to name a few examples.

Furthermore, in certain instances, an acquired signal may be indicative, at least in part, of a possible discernible altitude level. For example, some transmitting devices may be arranged to provide service to mobile devices within a particular portion of a building or structure, or possibly an outdoor space, which may be indicative of one or more discernible altitude levels. Indeed, in certain instances, a wireless signal of a transmitting device may indicate a certain location that may be indicative of one or more discernible altitude levels. For example, a wireless local area network or hotspot on a train may indicate via its signal that it may correspond to a discernible altitude level. In certain instances, one or more satellite positioning system (SPS) signals may be acquired by a mobile device, which may be used, at least in part, to determine an altitude level, and/or a possible direction of travel for the mobile device.

In another example, a mobile device may be paired with a computing device onboard an automobile (e.g., via Bluetooth, or other like communication capability), which may be indicative of a mode of transportation, and/or possibly lead to sharing of other information corresponding to the vehicle or its motion, such as, for example, location information, speed/velocity, heading, pitch, yaw, tilt, etc.

In certain example implementations, one or more barometer calibration processes may be selectively initiated based, at least in part, on a time-based threshold value. For example, it may be useful to initiate a barometer calibration process after a certain period of time corresponding to a time-based threshold value has passed since a last barometer calibration process. Conversely, it may be useful to not initiate a barometer calibration process until a certain period of time corresponding to a time-based threshold value has passed since a last barometer calibration process.

In certain example implementations, it may be useful for a mobile device to further identify an altitude uncertainty value corresponding to a discernible altitude level, and/or a reference pressure uncertainty value corresponding to reference atmospheric pressure. Such uncertainty values may, for example, be useful in other functions within the mobile device and/or possibly in other devices that may make use of the barometer onboard the mobile device. Similarly, an estimated altitude obtained from barometric pressure measurements may be associated with an estimated error in the estimated altitude.

In certain example implementations, it may be useful for a mobile device to obtain a weather report from another device and to affect an estimation of motion at a discernible altitude level based, at least in part, on the weather report. For example, in certain instances a forecasted rapid change in atmospheric pressure due to a storm front may indicate that, for a period of time, measurements from the barometer onboard the mobile device may be suspect, or that an operative mode of the barometer may be adjusted in some manner (e.g., increase samples, decrease samples), or possibly that more or fewer or different barometer calibration processes may be desirable, or the barometer-based altitude readings given more or less weight, just to name a few examples.

In certain example implementations, it may be useful for a mobile device to transmit one or more messages to one or more other devices which are indicative of a discernible altitude level and a reference atmospheric pressure. Thus, for example, a plurality of mobile devices may report such information and/or the like to a crowd sourcing server, a research service, etc., that may further process, refine, share, study, record, and/or otherwise use the information in some manner.

In certain example implementations, a mobile device may maintain a calibration history corresponding to a plurality of completed barometer calibration processes. For example, a calibration history may be indicative of a plurality of estimated discernible altitude levels and corresponding identified reference atmospheric pressures. For example, a calibration history may be indicative of various factors that may have been considered and/or otherwise used by the applicable techniques provided herein. In another example, a calibration history may be indicative of a learned routine, pattern, habit, schedule, etc., that may be of use to certain techniques as provided herein.

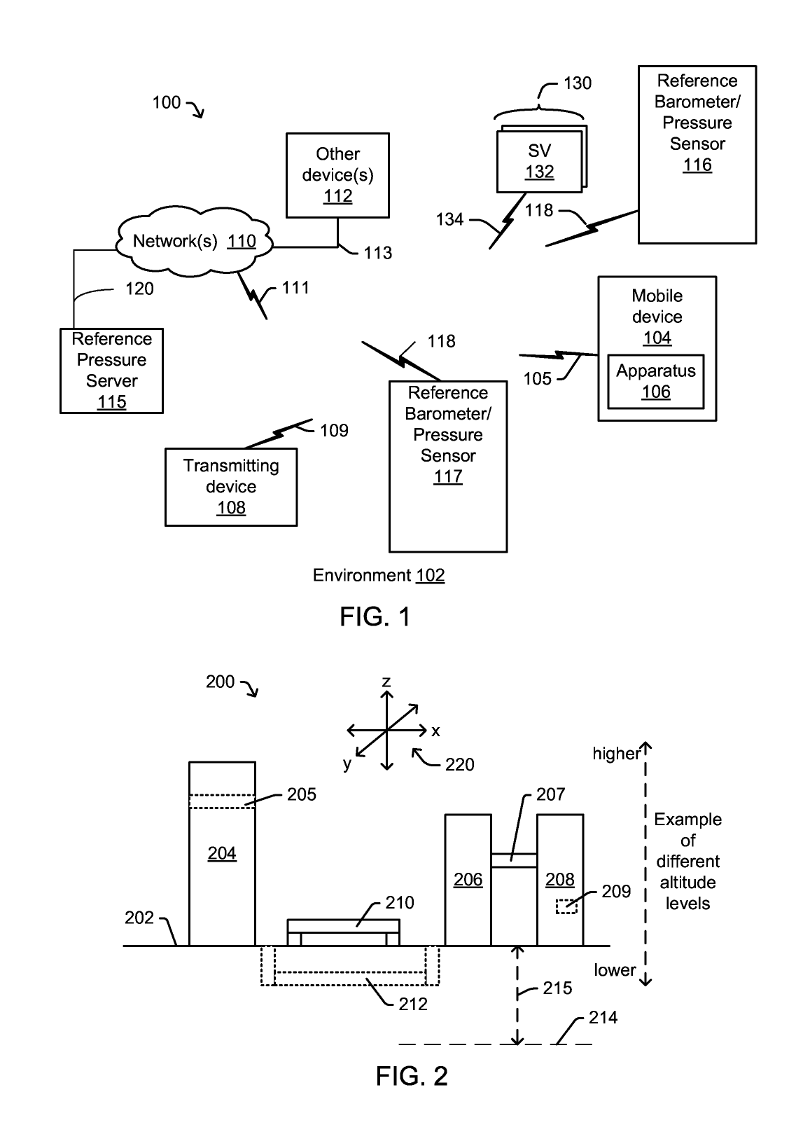

Attention is now drawn to FIG. 1, which is a schematic block diagram illustrating an example arrangement 100 comprising various example electronic devices within an environment 102. Environment 102 may comprise an outdoor space, one or more indoor spaces, and/or some combination thereof, in which a mobile device 104 may be located and moved about.

Mobile device 104 may be representative of any electronic device capable of being moved (carried and transported) in some manner by a person within environment 102. Hence, by way of example, mobile device 104 may comprise a cellular telephone, a smart phone, a tablet computer, a laptop computer, a wearable computer, a navigation and/or tracking device, etc. As illustrated, mobile device 104 may comprise an apparatus 106, which may be configured to provide and/or support in some manner one or more of the techniques provided herein. In certain instances, apparatus 106 may comprise hardware/firmware components, or possibly a combination of hardware/firmware and software components.

Accordingly, at times mobile device 104 may be capable of acquiring wireless signals 109 from one or more terrestrial-based transmitting devices 108, and/or wireless signals 111 from network(s) 110. Transmitting device 108 and/or network(s) 110 may be representative of various types of devices, including by way of some examples, a cellular base station, a repeater device, a fempto or pico cell device, a wireless local area network access device, a location beacon transmitting device, etc.

As illustrated in FIG. 1, mobile device 104, transmitting device 108 and network(s) 110 may, for example, communicate via wireless communication links 105, 109 and 111. Further, as illustrated network(s) 110 may be further connected over communication link 113 to one or more other devices 112. While communication link 113 is illustrated as comprising wired communication links, it should be understood that in certain instances communication link 113 may comprise various wired and/or wireless communication links.

Network(s) 110 is intended to represent all or part of one or more other electronic devices and/or communication facilities and/or resources capable of supporting wired and/or wireless electronic communication. Thus for example, network(s) 110 may comprise all or part of a telephone network, a cellular telephone network, a wireless communication network, an intranet, the Internet, and/or the like or some combination thereof.

Further, as shown in FIG. 1, mobile device 104 may, at times, acquire one or more SPS signals 134 transmitted by one or more space vehicles (SVs) 132 of one or more SPS systems 130.

Example arrangement 100 also comprises a reference barometer/pressure sensors 116 and 117 that may provide reference pressure measurements to other devices on network(s) 110 via wireless links 118. Here, reference barometer/pressure sensor 116 may be located at a known altitude and in sufficient proximity to mobile device 104 to experience or be affected by the same or similar weather conditions. In a particular implementation, reference barometer/pressure sensor 116 may be located at an airport or may be integrated with a BTS/cell tower (e.g., a BTS/cell tower serving mobile device 116).

In a particular alternative implementation, a separate pressure reference server 115 may keep track of various pressure reference values and be capable of providing mobile device 104 with a closest reference pressure value at known altitude, or providing an almanac of such preference reference values allowing mobile device 104 to seek out the closest pressure reference value. For example, mobile device 104 may transmit one or more messages to pressure reference server 115 including indicators or parameters indicating a location of mobile device 104. Such indicators or parameters may include, for example, latitude and longitude, a cell identifier for a serving cell, MAC address of a serving WLAN access point, postal code, street address, just to provide a few examples.

In response to the one or more messages from mobile device 104, pressure reference server 115 may provide a response message to mobile device 104 including a reference pressure and an altitude at which the reference pressure was obtained (e.g., altitude or reference barometer/pressure sensor 116 or 117), or it may provide a pressure referenced to mean sea level, or some other reference altitude. For example, the response message may identify a reference pressure source (e.g., reference barometer/pressure sensors 116 and 117) that is closest to a location of mobile device 104. From this reference pressure and altitude in a response message, a current altitude of mobile device 104 and current measurement from an on-board altimeter, mobile device 104 may calibrate the on-board altimeter.

In an alternative implementation, separate pressure reference server 115 or other source may also provide an altitude terrain map enabling mobile device 104 to determine an altitude ground level for its present estimated location. For example, mobile device may apply coordinates of its location (e.g., latitude and longitude or street address) to the altitude terrain map to determine a corresponding altitude for this location (e.g., using well known interpolation techniques). Alternatively, as mentioned elsewhere herein, mobile device 104 may determine its altitude from an SPS fix.

In this context an “altitude terrain map” may include any expression (e.g., such as in electronic form and/or stored in a memory) that relates a horizontal location (e.g., location in a plane or expressed by coordinates such as latitude and longitude) to a corresponding altitude. For example, an altitude terrain map may be expressed as one or more arrays in electronic form and/or as metadata provided with or a part of an electronic map. In a particular implementation, values in an altitude terrain map may define an altitude relative to a reference altitude (e.g., sea level) at a “ground level” indicative of an altitude of a terrain surface. In one particular implementation, an altitude terrain map may comprise metadata that is indicative of a plurality of discrete vertical levels that may be navigated in a particular horizontal region such as discrete floors of a building over a building footprint over a terrain. In one implementation, based on an altitude terrain map a special purpose computing apparatus, such as a processor in a mobile device, may be capable of determining or estimating an altitude of such a ground level at a corresponding horizontal location using well known interpolation techniques, for example.

According to an embodiment, a terrain surface at a ground level may comprise portions of an area are natural or graded portions including, for example, portions that are not enclosed by a structure. A ground level may also comprise the surface of a natural body of water such as a river or a lake. A ground level may also be indicative of an altitude of terrain on which a structure or building is supported. In a particular example, a ground level at the entrance of a building may be at about the same altitude as a lobby floor, for example. Here, other floors above or below the lobby floor may be above or below a ground level of the terrain.

According to an embodiment, mobile device 104 may apply a conversion to a pressure reference value obtained from reference barometer/sensor if mobile device 104 and reference barometer/sensor are located at different altitudes (e.g., where atmospheric pressure decreases as altitude increases). For example, mobile device 104 may estimate a pressure drift ΔP_{drift} to calibrate subsequent measurements obtained from its on-board altimeter according to expression (1) as follows:

ΔP_{drift}=Pₕ−P₀e^{-mgh/kT}−ΔP_{weather} (1)

Where
Pₕ is the pressure measured at point h (e.g., altitude of a mobile device);
P₀ is the pressure at reference point 0 (e.g., as provided in a message from a barometric pressure reference sever);
e is Euler's constant;
m is the mass per air molecule;
g is acceleration due to gravity;
h is a height difference from reference point 0 (e.g., a difference between an altitude at which P₀ is measured and an altitude of a mobile device as determined from a terrain map);
k is the Boltzmann constant;
T is temperature at the mobile device in Kelvin; and
ΔP_{weather} is the pressure change due to differences in weather between a location of the mobile device and a location of a sensor measuring P₀.

If P₀ is obtained from a source that is very near to the location of the mobile device, may be ΔP_{weather} negligible and possibly ignored without substantially affecting calibration of a barometric pressure sensor. A mobile device may apply ΔP_{drift} computed according to expression (1) to calibrate subsequent pressure measurements obtained from a barometric pressure sensor used for estimating an altitude of the mobile device. It should be understood that expression (1) provides merely an example of how a value of

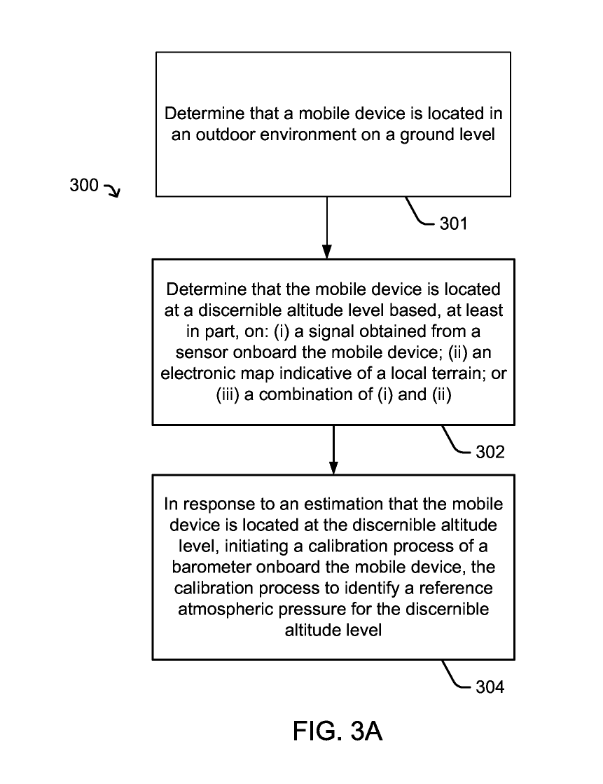

Attention is drawn next to FIG. 2, which is an illustrative diagram representing certain example structural and natural features of an urban environment 200 wherein a mobile device, for example, as in FIG. 1, may be transported about by a person, and wherein in certain instances a barometer onboard the mobile device may be opportunistically calibrated, in accordance with certain example implementations. As shown, different example altitude levels may be associated with such features.

As illustrated in FIG. 2, example environment 200 includes a side/cross-sectional view of cityscape having a ground level 202 from which multiple-floor buildings 204, 206 and 208 rise above. Ground level 202 may, for example, support a qualifying motion of person carrying mobile device 104 (FIG. 1). For example, such a person may walk or run (in pedestrian motion), or otherwise be transported may some vehicle or other form of conveyance operating at or about ground level 202.

In building 204, a higher floor 205 is indicated. Here, for example, in certain instances higher floor 205 may correspond to a work location for a person at certain times. Higher floor 205 may, for example, support a qualifying (pedestrian) motion of person carrying mobile device 104.

In building 208, a portion 209 of a mid-level floor is indicated. Here, for example, in certain instances portion 209 may correspond to a home location for a person. Portion 209 may, for example, support a qualifying (pedestrian) motion of person carrying mobile device 104 (FIG. 1).

A suspended bridge 207 is shown as connecting buildings 206 and 208 at an altitude level that is higher than ground level 202. Bridge 207 may, for example, support a qualifying (pedestrian) motion of person carrying mobile device 104.

A raised portion 210 is also shown at an altitude level that is higher than ground level 202. Raised portion 207 may, for example, support a qualifying motion of person carrying mobile device 104. For example, a person may walk along an elevated pathway or bridge, or may be carried by some mechanism along an elevated roadway or railway, etc., as represented by raised portion 207.

A lowered portion 212 is also shown at an altitude level that is lower than ground level 202. Lowered portion 212 may, for example, support a qualifying motion of person carrying mobile device 104. For example, a person may walk along a below-ground trench or tunnel, or may be carried by some mechanism along an underground roadway or railway, etc., as represented by lowered portion 212.

As shown in FIG. 2, in certain instances, ground level 202 may itself be offset by some distance 215 from some other reference level and/or point represented by item 214. By way of example, item 214 may represent a mean sea level, a center point of an Earth centered coordinate system, as are well known. By way further reference, a three axis coordinate system that may be applied is indicated by item 220, showing an x-axis, a y-axis and a z-axis, that may have its origin at Earth center. Thus, in such example coordinate system, different altitude levels increase/decrease along the z-axis. Similarly, as known, a gravity vector may be detected by certain inertial sensors which may similarly be aligned with the z-axis.

As pointed out above, a mobile device may calibrate an on-board altimeter based on a reference pressure and an altitude at which the reference pressure was obtained (e.g., from a server), the mobile device's current altitude and a current reading from the on-board altimeter. Also as pointed out above, a mobile device may apply coordinates of its location to an altitude terrain map to estimate or determine its altitude under certain conditions such as the mobile device being located a ground level such that its altitude at a particular location matches an altitude in the altitude terrain map corresponding to a current location of the mobile device. This may not be the case, however, if the mobile device is located in a multistory building above ground or on some other structure above ground as defined in the altitude terrain map. As discussed below in particular implementations, a mobile device may infer its altitude relative to a ground level as defined in an altitude terrain map based, at least in part, on motion attributes.

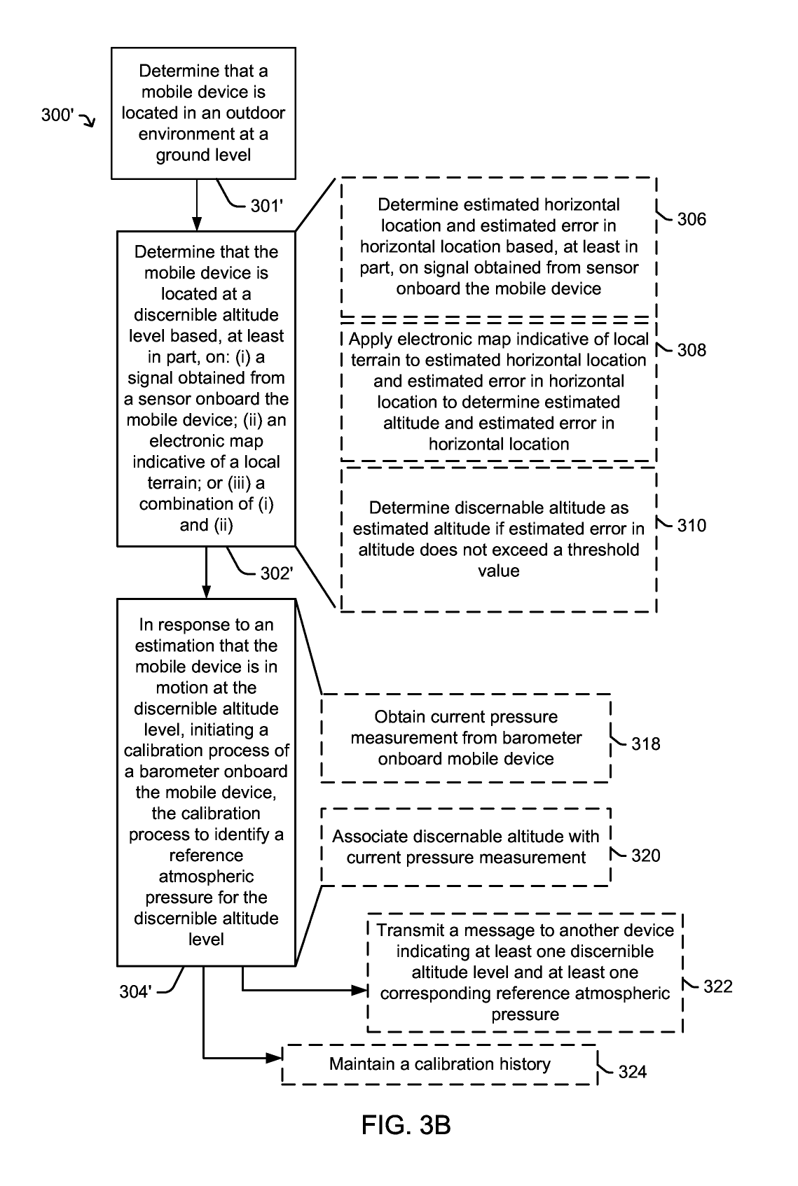

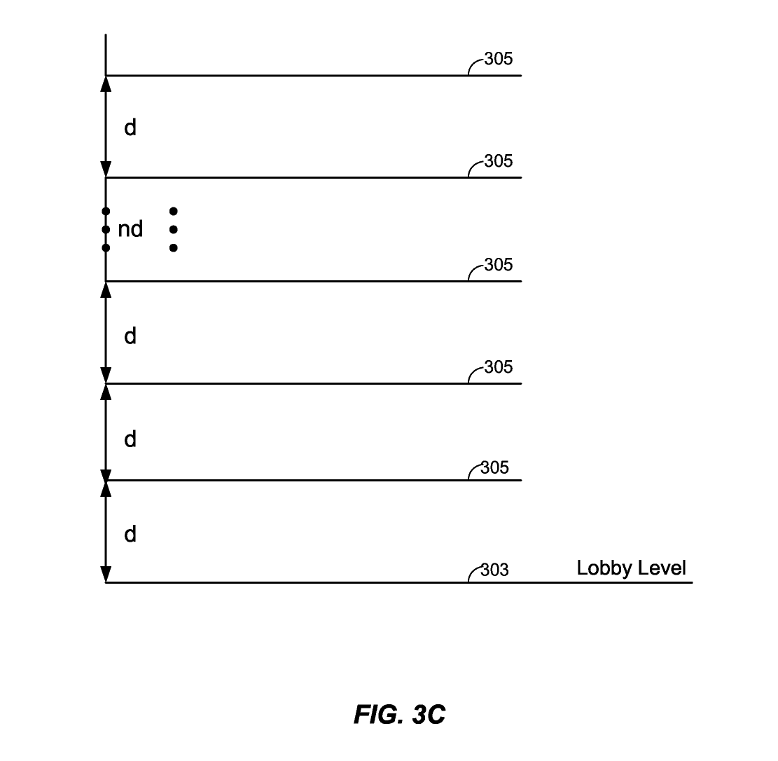

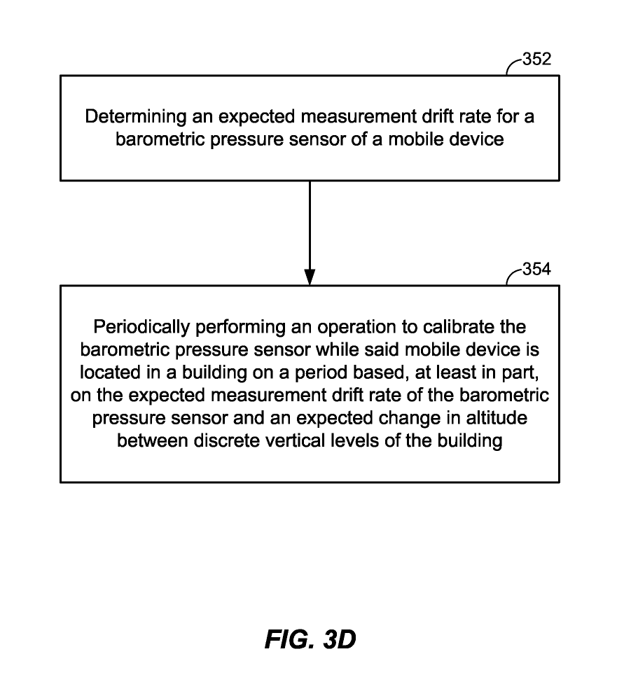

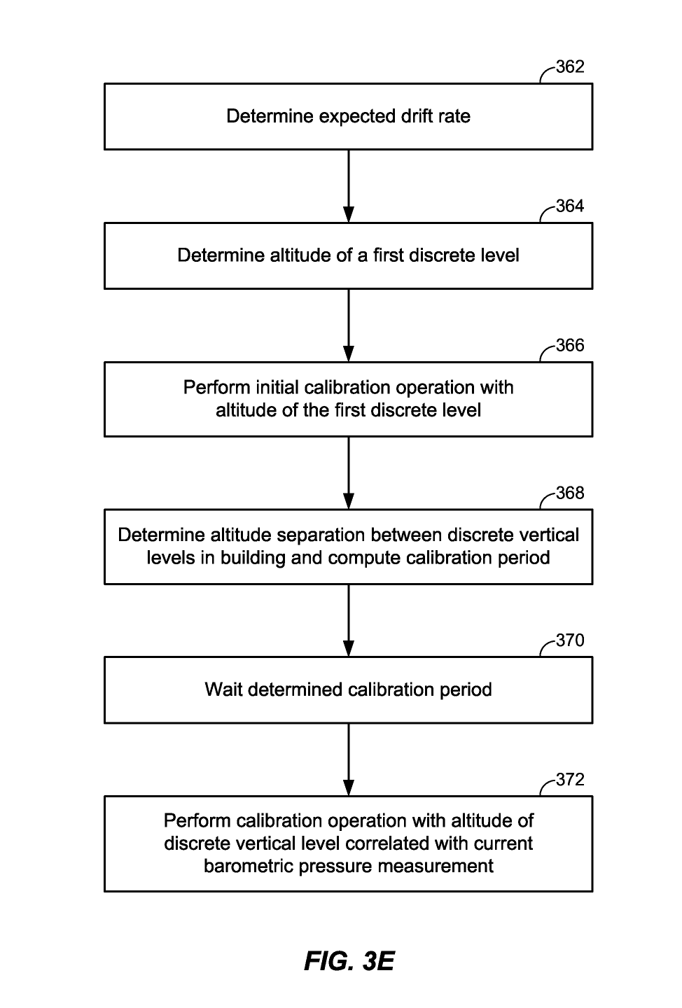

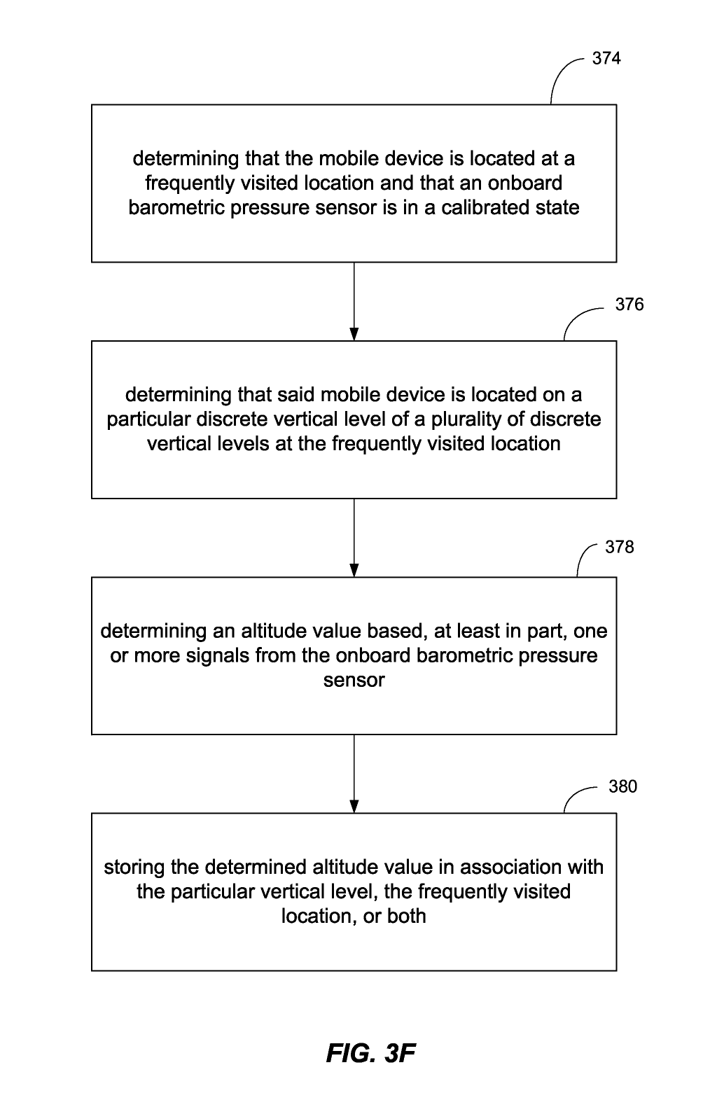

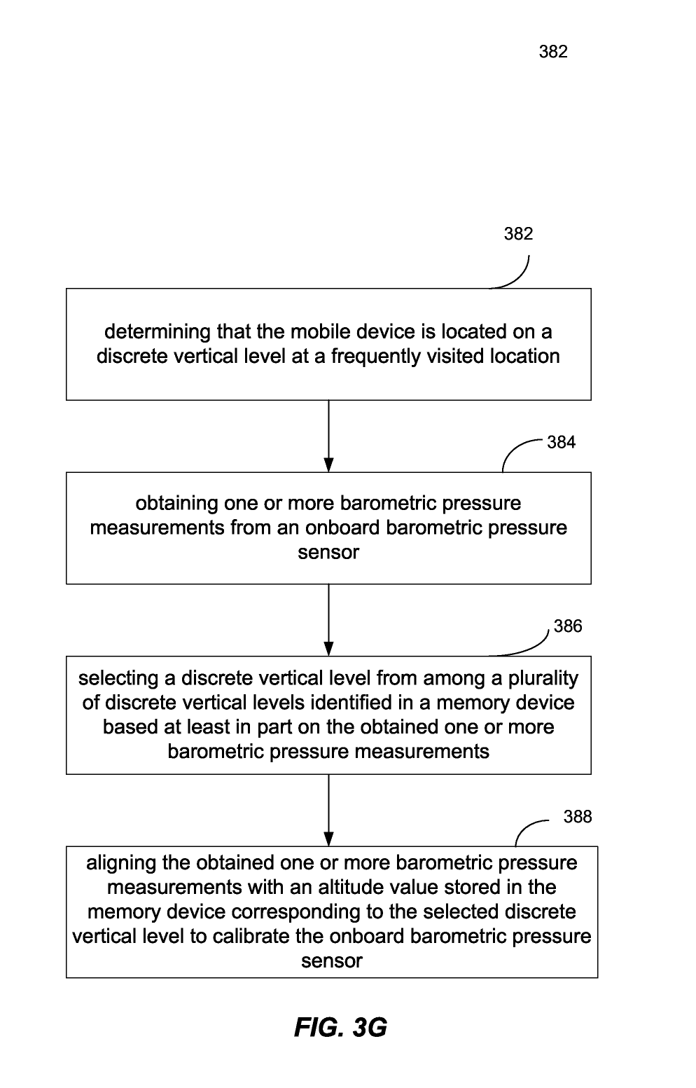

Attention is drawn next to FIG. 3A, which is a flow diagram illustrating an example process 300 that may be implemented using a mobile device to opportunistically calibrate a barometer onboard the mobile device. By way of example, process 300 may be implemented in whole or in part by mobile device 104 and/or apparatus 106 provisioned therein (FIG. 1). At block 301, a mobile device may determine that it is located on a ground level in an outdoor environment based on any one of several observations. In one implementation, signals from an onboard sensor (e.g., SPS receiver, light sensor, camera, temperature sensor or vibrational sensor, or any combination thereof). For example, a mobile device may determine that it is located on a ground level and in an outdoor environment based, at least in part, on a GNSS position fix based on acquisition of SPS signals. In another example, as discussed above, a mobile device may infer that it is in an outdoor environment if it is detected that the mobile device is in a qualifying motion reflective of a location on a ground level and in an outdoor environment.

In another example, a mobile device may comprise an almanac indicating horizontal locations and displacement of local buildings and subterranean structures (e.g., subways). Here, if an estimate of a horizontal location is determined to be located where no buildings or subterranean structures are present, a mobile device may infer that the mobile device is located on a ground level and an outdoor area.

In another example, a mobile device may be determined to be located on a ground level and in an outdoor area based, at least in part, on a history of movements (e.g., as detected based on signals generated by one or more inertial sensors onboard the mobile device) suggestive of travelling over a particular outdoor contour (e.g., matching a particular portion of an electronic terrain map).

A mobile device may determine that it is located in an outdoor environment and at a ground level based, at least in part, on one or more signals obtained from one or more sensors onboard the mobile device, an electronic map indicative of a local terrain, or some combination thereof. As mentioned, certain detectable motions of a mobile device may qualify as providing an opportunity to perform a barometer calibration, given a discernible altitude level being identified. For example, an estimated level trajectory may support an inference of a qualifying motion. For example, an estimated motion mode or mode of transportation may be indicative of a qualifying motion.

In an example scenario, a motion speed of a mobile device may be sufficiently high and sustained to infer that the mobile device is not constrained within a building or other indoor environment. For example, from a sufficiently high and sustained speed of a mobile device it may be inferred that the mobile device is travelling in an automobile on a road at a discernable “ground level.” In a particular example implementation, a latitude and longitude of the mobile device may be known roughly (e.g., from terrestrial positioning techniques such as Advanced Forward Trilateration (AFLT) or cell ID of a serving cell). If it is inferred that the mobile device is on a non-indoor ground level (e.g., based on a sufficiently high and sustained speed), an altitude of the mobile device may be estimated from an altitude terrain map by referencing the latitude and longitude to the map.

At block 302, a mobile device may determine that it is located at a discernable altitude with sufficient accuracy and precision to reliably calibrate a barometric pressure sensor. As discussed below at example block 304, this estimated altitude may then be used in a process to calibrate a barometric pressure sensor or altimeter on the mobile device (e.g., by computing ΔP_{drift} according to expression (1)). In one implementation, a mobile device may determine that it is located at a discernable altitude based, at least in part, on a reliable GNSS position fix that provides an altitude component.

In other example implementations, different types of motion may be used to infer an altitude of a mobile device. For example, if it is known that a mobile device is close to a body of water and a motion speed of the mobile device is similar to that of a boat travelling on the top surface of the body of water, it may be inferred that the altitude of the mobile device is that of the body of water. In another example, if it is known that a mobile device is close to a train track and a motion speed of the mobile device is similar to that of a train travelling on the train track, it may be inferred that the altitude of the mobile device is that of a train travelling on the train tracks. It should be understood, however, that these are merely examples of how it may be determined that a mobile device is at a discernable level based on motion, and claimed subject matter is not limited in this respect.

At example block 304, in response to determination that the mobile device is located at a discernible altitude level, one or more calibration processes corresponding to a barometer onboard the mobile device may be initiated, for example, to identify a reference atmospheric pressure for the discernible altitude level. As may be appreciated, such a reference atmospheric pressure may subsequently be used for a period of time to estimate an altitude level based on further atmospheric pressure measurement(s). For example, a difference between a subsequent atmospheric pressure measurement and such reference atmospheric pressure may indicate that the mobile device may be located on a particular floor or level of a building.

Attention is drawn next to FIG. 3B, which is a flow diagram illustrating an example process 300′ that may be implemented using a mobile device to opportunistically calibrate a barometer onboard the mobile device. By way of example, process 300′ may be implemented in whole or in part by mobile device 104 and/or apparatus 106 provisioned therein. In comparison with process 300 of FIG. 3A, example process 300′ comprises additional example blocks 306, 308 and 310 that may, in certain instances, be performed as part of example block 302′, additional example blocks 318 and 320 that may, in certain instances, be performed as part of example block 304′, and/or additional example blocks 322 and/or 324 that may, in certain instances, be performed in addition to example blocks 302, 302′, 304, and/or 304′.

At example block 302′, a mobile device may estimate that it is located at a discernible altitude level based, at least in part, on one or more signals obtained from one or more sensors onboard the mobile device, an electronic map indicative of a local terrain, or some combination thereof.

In the particular embodiment illustrated in FIG. 3B, block 302′ may be executed by multiple actions shown at blocks 306, 308 and 310. Block 306 may comprise obtaining estimates of latitude and longitude of a location of a mobile device, and estimated errors in these estimates. This may be obtained from one or more signals obtained from a sensor onboard the mobile device such as, for example, an SPS receiver, accelerometers, gravitometers, gyroscopes, microphones, WLAN transceiver, WWAN transceiver, WPAN transceiver, just to provide a few examples. Block 308 may apply an electronic terrain map (e.g., stored locally in a memory) to the estimated horizontal location and estimated error in that estimate to provide an estimated altitude and an estimated error in that altitude estimate (e.g., using well known interpolation techniques as discussed above). At block 310, if the estimated error in the altitude estimate is less than a threshold value, the discernable altitude may be determined to be the estimated altitude.

At example block 304′, in response to an estimation that the mobile device is located at the discernible altitude level, one or more calibration processes corresponding to a barometer onboard the mobile device may be initiated, for example, to identify a reference atmospheric pressure for the discernible altitude level.

As previously mentioned and now shown at example block 318, a mobile device may obtain one or more current barometric pressure measurements from an onboard barometric pressure sensor. The one or more current barometric pressure measurements obtained at block 318 may be obtained contemporaneously with measurements for determining the estimated horizontal location at block 306 or estimated altitude at block 308. Block 320 may then associate the one or more current barometric pressure measurements obtained at block 318 with the discernable altitude determined at block 310. The barometric pressure sensor obtaining the one or more barometric pressure measurements at block 318 may then be calibrated according to expression (1) above to, for example, compute a value for ΔP_{drift} for use in calibrating future barometric pressure measurements form the barometric pressure sensor by, for example, adjusting the future barometric pressure measurements by an amount based on ΔP_{drift}.

In certain example implementations, process 300′ may, at example block 322, comprise having the mobile device transmit one or more messages to one or more other devices, and such messages may indicate, at least in part, a discernible altitude level and corresponding reference atmospheric pressure, or it may provide a reference pressure, relative to an agreed standard altitude, such as mean sea level.

In certain example implementations, process 300′ may, at example block 324, comprise maintaining a calibration history. For example, a calibration history may correspond to one or more completed barometer calibration processes and may be indicative of one or more estimated discernible altitude levels and corresponding identified reference atmospheric pressures.

In particular scenarios, a mobile device may not be able to discern an altitude of its location with sufficient reliability or accuracy for calibration of an onboard barometric pressure sensor. For example, an estimated error in an estimated altitude determined at block 308 may exceed a threshold value at block 310, indicating that the estimated altitude is not sufficiently reliable or accurate. Nevertheless, in particular implementations, a mobile device may still be capable of correcting for weather effects. As pointed out above in connection with FIG. 1, reference pressure server 115 may store a history of reference barometric pressure measurements obtained by reference barometric pressure sensors 116 and 117. This stored history of barometric pressure measurements may be used to calibrate measurements obtained at a current time t₁ from an onboard barometric pressure sensor for changes in weather according to expression (2) as follows:

ΔP_{weather}(t₁)=P_{ref}(t₁)−P_{ref}(t₀) (2)

where:

P_{ref}(t₁) is a reference pressure value obtained at a current time t₁ at a reference point (e.g., at a location of a reference barometric pressure sensor);

P_{ref}(t₀) is a reference pressure value obtained at a time in the past t₀ (e.g., at a time when an onboard barometric pressure sensor was previously calibrated).

According to an embodiment, a mobile device may calibrate an onboard barometric pressure sensor according to expression (2) to correct for changes in weather from a time t₀, when the mobile device was previously calibrated, to a time t₁. In one particular implementation, a mobile device may obtain a value for P_{ref}(t₀) from a reference pressure server at some time in the past, and then store the obtained value for P_{ref}(t₀) in an onboard memory device. For example, the mobile device may have used the obtained value for P_{ref}(t₀) in a previous calibration operation. Alternatively, the mobile device may transmit a query message to a reference pressure server (e.g., reference pressure server 115) requesting a pressure reference value for a particular reference barometer/pressure sensor obtained at time t₀.

A mobile device may reliably calibrate an onboard barometric pressure sensor based on a value for P_{ref}(t₀) (e.g., using expression (1) above) if the mobile device at time t₀ is sufficiently proximate to a location of a reference sensor obtaining value P_{ref}(t₀) to avoid significant variation in weather between the location of the reference sensor and a location of the mobile at time t₀. Similarly, the mobile device may reliably calibrate the onboard barometric pressure sensor at time t₁ if the mobile device at time t₁ is also sufficiently proximate to the reference sensor obtaining value P_{ref}(t₁) to avoid significant variation in weather between the location of the reference sensor and a location of the mobile at time t₁.

In particular environments, such as indoor environments, a mobile device may not be capable of acquiring SPS signals that are sufficiently accurate to estimate its location with a threshold for horizontal or vertical accuracy. In particular environments, a mobile device in a multilevel indoor environment (e.g., a multistory building) may be inferred to be located on one of a number of discrete vertical levels (e.g., different floors of a building on which a mobile device may be located). The mobile device may then from time to time calibrate its altimeter to correct for measurement drift. For example, if a mobile device is located on a particular floor of a building, it may be desirable to perform a calibration operation sufficiently often to avoid a drift of more than one half an altitude separation between the particular floor and an adjacent floor. As such, particular example implementations are directed to determining a duration (e.g., a maximum duration) between consecutive calibration operations.

As pointed out above, a mobile device may calibrate an on-board altimeter based on a reference pressure and an altitude at which the reference pressure was obtained or referenced to (e.g., obtained from reference pressure server 115), the mobile device's current altitude and a current measurement reading from the on-board altimeter. Also as pointed out above, in particular environments where a mobile device may not reliably obtain a GNSS position fix (e.g., in indoor environments), the mobile device may employ different means for obtaining its current altitude. As pointed out above, by periodically calibrating an altimeter according to an estimated measurement drift of an altimeter, a mobile device in a building with discrete vertical levels may be able to maintain calibration of measurements from the altimeter to support positioning operations.

FIG. 3C shows floors 303 and 305 of a multistory building according to embodiment. Floor 303 may comprise a floor at a known or verifiable altitude (e.g., a lobby floor) while floors 305 are on levels set off vertically from floor 303. FIG. 3C shows that floors 305 are above (i.e., have a higher altitude than) floor 303. In other embodiments however, one or more floors of a building may be below a lobby level. As shown in FIG. 3C, for the purposes of illustration, adjacent floors are separated by a uniform altitude separation d. In other scenarios, however, an altitude separation between adjacent floors need not be uniform. For example, a lobby of a building (e.g., a hotel lobby) may be separated from a first floor (floor adjacently above the lobby floor) by a twelve-foot altitude separation while the first floor may be separated from a second floor (floor adjacently above the first floor) by a ten-foot altitude separation.

In the presently illustrated embodiment, a mobile device entering a building as depicted in FIG. 3C may enter floor 303 from an outdoor environment where an altitude is known or reliably estimated by the mobile device from an GNSS position fix. If an altitude of the outdoor environment at the entrance to the lobby is roughly the same as that of floor 303, the mobile device may maintain an accurate estimate of an altitude of floor 303 in a memory (e.g., based on a last position fix before entering the building). In other scenarios, floor 303 need not be at a lobby level but instead comprise a floor leading to an outdoor area such as a terrace or balcony that is at about the same altitude as floor 303. In a particular implementation, following estimation of a current altitude based on a GNSS position fix in an outdoor environment and as the mobile device proceeds to floor 303, a mobile device may assess whether the estimated current altitude remains reliable based, at least in part on signals from inertial sensors which may indicate any vertical accelerations indicative of a change in altitude.

Based on a stored estimate of the altitude of floor 303, a mobile device may calibrate an on-board altimeter or barometric pressure sensor. For example, the mobile device may compute a measurement drift based on expression (1) based on the stored estimated altitude of floor 303, a raw measurement obtained while located on floor 303, and a reference pressure and corresponding reference altitude (e.g., obtained from reference pressure server 115). If the mobile device subsequently moves from floor 303 to a different floor (e.g., a floor 305), however, the stored estimated altitude of floor and raw measurement obtained while located on floor 303, by themselves, may not be sufficient for performing a subsequent calibration operation according to expression (1).

As may be observed from FIG. 3C, adjacent floors are separated by the same altitude separation d. According to an embodiment, a mobile device moving from floor 303 to a different floor may experience a change in altitude from that of floor 303 by an integer multiple of d. Here, an altitude of a mobile device moving from floor 303 to a different floor may be inferred to be located on one a plurality of discrete vertical levels set off in altitude from floor 303 by integer multiples of d.

Following an initial calibration of an on-board altimeter at floor 303 as discussed above, a mobile device may obtain a subsequent altitude measurement from its on-board altimeter. An altitude of the mobile device may be inferred to be that of a particular discrete vertical level (from among the aforementioned plurality of discrete vertical levels) corresponding to (e.g., closest to) the subsequent altitude measurement. The mobile device may then calibrate its on-board altimeter according to expression (1) using the subsequent altitude measurement (or corresponding barometric pressure measurement), the altitude of the particular discrete vertical level corresponding to the subsequent altitude measurement, and a reference pressure and corresponding reference altitude.

According to an embodiment, a mobile device performing an initial calibration of its altimeter while located at floor 303 may periodically perform subsequent calibration operations based on expression (1) thereafter. If the subsequent calibration operations are performed sufficiently often relative to an expected measurement drift rate for an on-board barometric pressure sensor obtaining the draft rate, a mobile device may maintain calibration indefinitely. In a particular implementation, it may be desirable or useful to recalibrate an altimeter before a drift of the altimeter (since the most recent calibration) operation exceeds one half an altitude separation between adjacent floors (e.g., d). For example, a permitted or maximum duration between consecutive executions of a calibration operation may be set according to expression (3) as follows:

T<d/(2×DR) (3)

where:

T is a duration between consecutive calibration operations; and

DR is an expected rate of drift of altimeter measurements.

FIG. 3D is a flow diagram of a process to calibrate an onboard barometric pressure sensor of a mobile device according to an embodiment. Block 352 may determine an expected measurement drift rate for a barometric pressure sensor using any one of several different techniques. Such an expected measurement drift rate may comprise a signal or a state value that is stored in a memory and represents an expected amount by which a deviation of measured barometric pressure or altitude from actual barometric pressure increases over time. Such a measurement drift rate may also be expressed in units of atm/sec or m/sec. In a particular implementation, block 352 may be performed, at least in part, by a computing device such as processing unit(s) 402 in combination with memory 404, for example. Block 354 may then determine a permitted (e.g., maximum) duration between consecutive operations to calibrate the sensor based, at least in part, on the expected measurement drift rate of the barometric pressure sensor and an expected change in altitude between discrete vertical levels of the building the expected drift rate. In a particular implementation, a mobile device may periodically calibrate an on-board barometric pressure sensor and the duration determined at block 354 may specify a duration of a period between calibration operations. As such, the period for performing such a periodic calibration may be determined based, at least in part, on an expected measurement drift rate of the barometric pressure sensor and an expected change in altitude between discrete vertical levels of the building. An expected change in altitude may comprise a signal or state stored in a memory representing an expected altitude separation between adjacent floors of a building. The duration (e.g., period) may also comprise a signal or state stored in a memory representing a time period between consecutive operations to calibrate the barometric pressure sensor. In a particular implementation, blocks 352 and 354 may be performed, at least in part, by a computing device such as processing unit(s) 402 in combination with memory 404, to calibrate altimeter/barometric pressure sensor(s) 424, for example.

FIG. 3E is a flow diagram of a process by which a mobile device may calibrate measurements of an on-board barometric pressure sensor or altimeter according to an alternative implementation. Block 362 may determine an expected drift rate of an altimeter or barometric pressure sensor using any one of several techniques. For example, block 362 may obtain an expected drift rate determined as a factory setting and stored in a memory. Alternatively, block 362 may evaluate a history of measurements obtained by the altimeter or barometric pressure sensor paired with actual/reference values of altitude or barometric pressure to characterize a rate at which measurements obtained by the altimeter or barometric pressure sensor deviate over time. It should be understood, however, that these are merely example techniques for determining an expected drift rate of a barometric pressure sensor, and claimed subject matter is not limited in this respect.

Block 364 may determine an altitude of a first or initial discrete vertical of a building. As discussed above, this may be accomplished by obtaining an GNSS position fix in an outdoor area at an entrance to the first or initial discrete vertical level (e.g., at the entrance to a lobby, or a balcony or terrace as discussed above). Alternatively, the altitude of a first or initial floor of a building may be provided through a different sensor (e.g., a bar code reading) or user input provided via a user interface (e.g., provided to a touchscreen).

Block 366 may perform an initial calibration operation based on the altitude of the first discrete vertical level determined at block 364. As discussed above, this may be accomplished by estimating a pressure drift according to expression (1) based, at least in part, the first discrete vertical level determined at block 364, a contemporaneous raw measurement obtained by the on-board altimeter, and a reference pressure and corresponding reference altitude at which the reference pressure was obtained.

Block 368 may determine an altitude separation between discrete vertical levels of a building (e.g., d as shown in FIG. 3C). This may be provided to the mobile device as positioning assistance data provided by a server (e.g., pressure reference sensor 115). Alternatively, an altitude separation between discrete vertical levels of a building may be provided as a user input via a user interface. Based, at least in part, on the altitude separation between discrete vertical levels of the building and the expected drift rate determined at block 362, block 368 may further compute a calibration period. For example, block 368 may compute a duration between consecutive calibration operations subject to a constraint in expression (3) discussed above.

In one particular embodiment, discrete vertical levels in a building may not be separated by a uniform altitude separation. Here, to compute a duration between consecutive calibration operations block 368 may determine a single value to represent an altitude separation between discrete vertical levels. Block 368 may determine an average separation or a minimum separation between adjacent discrete vertical levels for computation of a duration according to expression (3).

Following an initial wait based on the computed duration calibration period at block 370, block 372 may perform calibration operation. Here, block 372 may identify candidate altitudes as the altitude of the first discrete level determined at block 364 and additional altitudes set off from the first discrete level at the altitude separation between discrete vertical levels determined at block 368. The mobile device may obtain a current measurement of an altitude based on a pressure measurement obtained by the on-board altimeter or barometric pressure sensor (which is calibrated according to a pressure drift computed in a most recent calibration operation). Then, the mobile device may select a candidate altitude from among the candidate altitudes as being closest to the measured altitude. The mobile device may then compute an updated pressure drift value according to expression (1) based, at least in part, on the selected candidate altitude, the current measurement of altitude, and a reference pressure and corresponding reference altitude. The mobile device may then wait for the duration at block 370 before repeating a calibration operation at block 372. Accordingly, a mobile device may move about on different floors of a multi-story building and maintain calibration of its barometric pressure measurements provided that calibrated barometric pressure measurements are sufficiently accurate to correctly correlate with one of the candidate altitudes.

In one particular implementation, the duration computed at block 368 may specify a period for a periodic calibration of an on-board barometric pressure sensor. For example, without user interaction, a mobile device may cycle between blocks 370 and 372 on the determined duration to maintain calibration of measurements provided by the on-board barometric pressure sensor. If while waiting at block 370 the mobile device performs a calibration operation in response to an external event (e.g., a user initiate calibration operation), the mobile device may restart the wait at block 370 before proceeding to a subsequent calibration operation at block 372.

As discussed above, a mobile device may measure or determine a drift experienced by a barometric pressure sensor expressed as a drift rate (e.g., atm/min). If a mobile device is located within a multistory building there may be no need to return to a known altitude (e.g., lobby level) to calibrate the barometric pressure sensor if the barometric pressure sensor is re-calibrated sufficiently frequent for a given drift rate. For example, pressure may be monitored using periodic sampling.

In the particular implementation of FIG. 3C, discrete vertical levels may be presumed to be offset by a uniform vertical spacing. FIGS. 3F and 3G are directed to an alternative embodiment in which discrete vertical levels at a frequently visited location (e.g., vertical floors in a building such as a home where a user lives, an office building where the user works, a building of a school where the user is a student, etc). In one example, a mobile device may determine a location of the mobile device to be at or in the vicinity of the frequently visited location based, at least in part, on an outdoor GNSS position fix from acquisition of SPS signals (e.g., at an entrance to a particular building comprising the frequently visited location). In a particular implementation, blocks 362, 364, 366, 368, 370 and 372 may be performed, at least in part, by a computing device such as processing unit(s) 402 in combination with memory 404, to calibrate altimeter/barometric pressure sensor(s) 424, for example.

FIG. 3F is a flow diagram of a process for obtaining measurements of altitudes for discrete vertical levels to be maintained as a reference for future calibration operations according to an embodiment. At block 374, a mobile device may determine that it is located at a frequently visited location (e.g., as described above, for example) and that an onboard barometric pressure sensor is in a calibrated state. In this context, a “frequently visited location” comprises a portion of a navigable region that a mobile device has visited in the past or is expected to visit at some time in the future. For example, a frequently visited location may comprise an office building, a single family dwelling or an apartment building. In a particular implementation, a frequently visited location may comprise a location determined with reference to an electronic map. In one example, a frequently visited location may be determined by a user input to a device such as labels applied to locations defined as a “home,” “office,” “gym,” “store,” etc. In another example, a frequently visited location may comprise an area within a map region through which a location of a mobile device has been tracked through over time (e.g., a history of past location estimates being in the area within the map). It should be understood, however, that these are merely examples of a frequently visited location and claimed subject matter is not limited in this respect. A “calibrated state” of a barometric pressure sensor, as used herein, indicates a condition in which measurements of the barometric pressure obtained from the barometric pressure sensor may be mapped to an actual barometric pressure with sufficient accuracy to support an application or perform a particular task. Referring to expression (1) for a particular non-limiting embodiment, a barometric pressure sensor may be in a calibrated state if values for ΔP_{drift} or ΔP_{weather}, or a combination of ΔP_{drift} or ΔP_{weather}, are known (e.g., by a mobile device as stored in a memory) with a certain accuracy or certainty (e.g., an expected error in estimates of ΔP_{drift} or ΔP_{weather}, or a combination of ΔP_{drift} or ΔP_{weather} is less than a threshold value). It should be understood, however, that this is merely an example of how a barometric pressure sensor may be determined to be in a calibrated state and claimed subject matter is not limited in this respect. According to an embodiment, a mobile device may calibrate its onboard barometric pressure sensor (e.g., place the barometric pressure sensor in a calibrated state) for subsequent pressure measurements in an outdoor area as discussed above (e.g., by obtaining GNSS position fix providing an accurate/reliable altitude estimate and a reference pressure value).

Block 376 may determine that the mobile device is located at a particular discrete vertical level (e.g., a floor of a building). In one embodiment, the mobile device may store a map identifying the frequently visited area as a point of interest, structure, etc., and including other details or metadata regarding the frequently visited location such as specific boundaries of the frequently visited location area such as locations of exterior walls, number of floors, etc. However, the map may not contain altitudes of discrete vertical levels (e.g., specific building floors) with sufficient accuracy for use in calibrating a barometric pressure sensor. In one implementation, a user may interact with a user interface (e.g., a touchscreen, microphone, detectable gesture etc.) to signal/indicate that the mobile device is located on a particular discrete vertical level. Alternatively, a mobile device may process signals from one or more accelerometers to detect transitions between discrete vertical levels followed by a duration of time in which a barometric pressure measured at an onboard barometric pressure sensor moves within a very small range. These measurements may be combined with acquisitions of local indoor signals (e.g., from IEEE std. 802.11 transmitters indicating a particular floor of a building) for inferring that the mobile device is located on a particular discrete vertical level of a plurality of discrete vertical levels. It should be understood, however, that these are merely examples of how a mobile device may determine that it is located on a particular discrete vertical level of a plurality of discrete vertical levels at a frequently visited location, and claimed subject matter is not limited in this respect.

At block 378, with a calibrated barometric pressure sensor (as discussed above), the mobile device may measure an altitude at a particular discrete vertical level and store the measured altitude in a memory (e.g., in a table or other structure associating discrete vertical levels of the frequently visited location with altitude values). Here, for example, the mobile device may compute an altitude at the particular vertical level based, at least in part, on barometric pressure measurements obtained at the barometric pressure sensor and corrected for ΔP_{drift} or ΔP_{weather}, or a combination of ΔP_{drift} and ΔP_{weather}. Blocks 376 and 378 may be repeated for multiple discrete vertical levels. Alternatively, after an altitude of a first discrete vertical level is determined at block 378 the altitudes of other discrete levels may be determined if it is assumed that the other discrete vertical levels are offset in altitude from the first discrete vertical level by known amounts. Block 380 may store altitude values determined at block 378 in a memory device (e.g., memory 404) for use in future calibration operations such as a calibration operation performed according to the process of FIG. 3E or 3F.

Using altitude values associated with discrete vertical levels stored in a memory (e.g., using the process of FIG. 3F), a mobile device may calibrate (or recalibrate) barometric pressure measurements of its onboard barometric pressure sensor as it approaches or returns to a discrete vertical level. FIG. 3G is a flow diagram of a process that may be used for calibrating a barometric pressure sensor, according to an embodiment. At block 382, a mobile device may determine that it is located on a discrete vertical level at a frequently visited location as described above at blocks 376, for example. At block 384, the mobile device may obtain a barometric pressure measurement from its onboard barometric pressure sensor. Block 386 may select a discrete level from among a plurality of discrete vertical levels based, at least in part, on barometric pressure measurement(s) obtained at block 384. In one implementation, a memory device on the mobile device may store altitude values corresponding to the discrete vertical levels (e.g., linear altitude values or barometric pressure values stored in association with discrete vertical levels of the frequently visited location as indicate above for block 380). Here, block 386 may apply a well known conversion of the obtained barometric pressure measurement to units of altitude (e.g., meters). For example, block 386 may map barometric pressure sensor measurements obtained at block 384 to estimated altitude values according to may be mapped according to expression (4) as follows:

est.(alt)=kT/mg In[(Pₘₑₐₛ−ΔP_{drift}−ΔP_{weather})/Pₛₑₐ] (4)

where:
Pₘₑₐₛ is a value of a pressure measurement obtained at a barometric pressure sensor; and
Pₛₑₐ is a barometric pressure at sea level

Here, block 386 may compare a value for est. (alt) with altitude values stored in a memory device corresponding to the plurality of discrete vertical levels. It should be understood, however, that expression (4) is merely an example of a mapping of a barometric pressure measurement to an estimated, and claimed subject matter is not limited in this respect.

Block 388 may then align the barometric pressure measurement obtained at block 384 and the stored altitude value of the selected discrete level to calibrate subsequent barometric pressure measurements according to expression (1) above, for example.

According to an embodiment, recalibration may be performed as set forth in FIG. 3G based on pre-stored altitudes corresponding to floors at a known location. For a relatively stable barometric pressure sensor, this can be done relatively infrequently, possibly triggered by measured pressure drift corresponding to weather while on a discrete level (e.g., not associated with walking/riding/movement between floors) or triggered periodically (daily) or by some action (plugged into a charge at known location) or triggered by a periodic pressure reading showing that the measured pressure is different from the pressure assigned to a discrete level in the table of floors by greater than some threshold value (for example, the pressure change associated with a change in altitude of ⅓ of a floor.

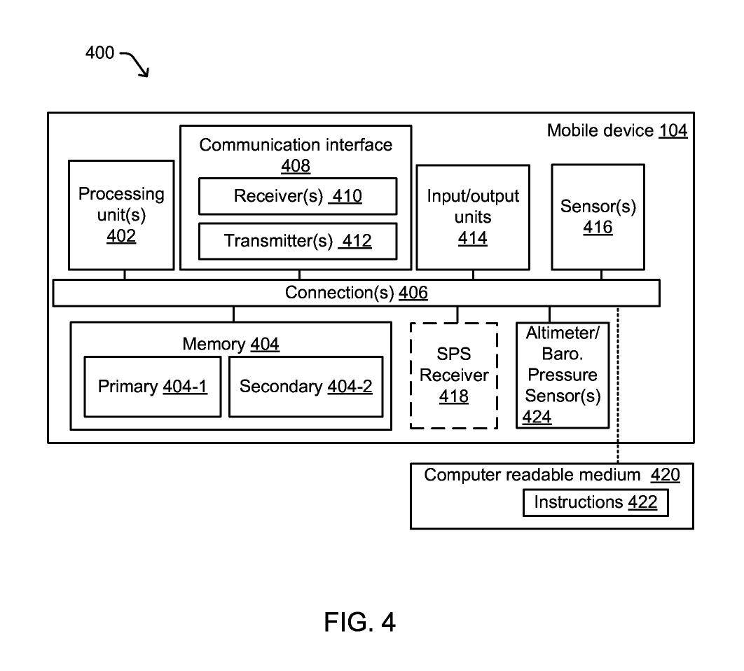

Attention is now drawn to FIG. 4, which is a schematic diagram illustrating certain features of an example special purpose computing platform 400 that may be provisioned within a mobile device 104 and/or apparatus 106, in accordance with certain example implementation.

As illustrated special computing platform 400 may comprise one or more processing units 402 (e.g., to perform data processing in accordance with certain techniques provided herein) coupled to memory 404 via one or more connections 406 (e.g., one or more electrical conductors, one or more electrically conductive paths, one or more buses, one or more fiber-optic paths, one or more circuits, one or more buffers, one or more transmitters, one or more receivers, etc.). Processing unit(s) 402 may, for example, be implemented in hardware or a combination of hardware and software. Processing unit(s) 402 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof. Processing unit(s) 402 may, for example, perform computer implementable instructions corresponding to one or more applications(s) 152 (FIG. 1).

Memory 404 may be representative of any data storage mechanism. Memory 404 may include, for example, a primary memory 404-1 and/or a secondary memory 404-2. Primary memory 404-1 may comprise, for example, a random access memory, read only memory, etc. While illustrated in this example as being separate from the processing units, it should be understood that all or part of a primary memory may be provided within or otherwise co-located and coupled with processing unit 402 or other like circuitry within mobile device 104. Secondary memory 404-2 may comprise, for example, the same or similar type of memory as primary memory and/or one or more data storage devices or systems, such as, for example, a disk drive, an optical disc drive, a tape drive, a solid motion state memory drive, etc.

In certain implementations, secondary memory may be operatively receptive of, or otherwise configurable to couple to, a non-transitory computer readable medium 420. Memory 404 and/or non-transitory computer readable medium 420 may comprise instructions 422 for use in performing data processing, e.g., in accordance with the applicable techniques as provided herein.

Special purpose computing platform 400 may, for example, further comprise one or more communication interface 408. Communication interface 408 may, for example, comprise one or more wired and/or wireless network interface units, radios, modems, etc., represented here by one or more receivers 410 and one or more transmitters 412. It should be understood that in certain implementations, communication interface 408 may comprise one or more transceivers, and/or the like. Further, it should be understood that although not shown, communication interface 408 may comprise one or more antennas and/or other circuitry as may be applicable given the communication interface capability.

In accordance with certain example implementations, communication interface 408 may, for example, be enabled for use with various wired communication networks, e.g., such as telephone system, a local area network, a wide area network, a personal area network, an intranet, the Internet, etc.

In accordance with certain example implementations communication interface 408 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMBP capability), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 408 may further provide for infrared-based communications with one or more other devices. A WLAN may, for example, comprise an IEEE 802.11x network, and a WPAN may comprise a Bluetooth network, an IEEE 802.15x, for example. Wireless communication implementations described herein may also be used in connection with any combination of WWAN, WLAN or WPAN.

Mobile device 104 may, for example, further comprise one or more input and/or output units 414. Input and/or output units 414 may represent one or more devices or other like mechanisms that may be used to obtain inputs from and/or provide outputs to one or more other devices and/or a user. Thus, for example, input and/or output units 414 may comprise various buttons, switches, a touch pad, a trackball, a joystick, a touch screen, a keyboard, a microphone, a camera, and/or the like, which may be used to receive one or more user inputs. In certain instances, input and/or output units 414 may comprise various devices that may be used in producing a visual output, an audible output, and/or a tactile output for a user. For example, input and/or output units 414 may be used to present a video display, graphical user interface, positioning and/or navigation related information, visual representations of electronic map, routing directions, etc., via a display mechanism and/or audio mechanism.

Mobile device 104 may, for example, comprise one or more sensors 416. For example, sensor(s) 416 may represent one or more environmental sensors, such as, e.g., a magnetometer or compass, a barometer or altimeter, etc., and which may be useful for positioning. For example, sensor(s) 416 may represent one or more inertial sensors, which may be useful in detecting certain movements of mobile device 104. Thus for example, sensor(s) 416 may comprise one or more accelerometers, one or one or more gyroscopes. Further, in certain instances sensor(s) 416 may comprise and/or take the form of one or more input devices such as a microphone, a camera, a light sensor, etc. In addition, mobile device may comprise altimeter/barometric pressure sensor(s) 424 capable of obtaining barometric pressure measurements and/or measuring an altitude. Measurements obtained from altimeter/barometric pressure sensor(s) 424 may be stored in memory 404 for use in positioning operations, for example. In addition, Measurements obtained from altimeter/barometric pressure sensor(s) 424 may be calibrated using processes and techniques described herein. In this context, barometer, barometric pressure sensor and altimeter may be used interchangeably throughout this specification.

Mobile device 104 may, for example, comprise an SPS receiver 418 capable of acquiring SPS signals 134 via one or more antennas (not shown). SPS receiver 418 may also process, in whole or in part, SPS signals 134 for estimating a position and/or a motion of mobile device 104. In certain instances, SPS receiver 418 may comprise one or more processing unit(s) (not shown), e.g., one or more general purpose processors, one or more digital signal processors DSP(s), one or more specialized processors that may also be utilized to process acquired SPS signals, in whole or in part, and/or calculate an estimated location of mobile device 104. In certain implementations, all or part of such processing of acquired SPS signals may be performed by other processing capabilities in mobile device 104, e.g., processing unit(s) 402, memory 404, etc., in conjunction with SPS receiver 418. Storage of SPS or other signals for use in performing positioning operations may be performed in memory 404 or registers (not shown).

In certain instances, sensor(s) 416 may generate analog or digital signals that may be stored in memory 404 and processed by DSP(s) (not shown) or processing unit(s) 402 in support of one or more applications such as, for example, applications directed to positioning or navigation operations based, at least in part, on one or more positioning functions.

Processing unit(s) 402 may comprise a dedicated modem processor or the like that may be capable of performing baseband processing of signals acquired and downconverted at receiver(s) 410 of communication interface 408 or SPS receiver 418. Similarly, a modem processor or the like may perform baseband processing of signals to be upconverted for transmission by (wireless) transmitter(s) 412. In alternative implementations, instead of having a dedicated modem processor, baseband processing may be performed by a general purpose processor or DSP (e.g., general purpose and/or application processor). It should be understood, however, that these are merely examples of structures that may perform baseband processing, and that claimed subject matter is not limited in this respect. Moreover, it should be understood that the example techniques provided herein may be adapted for a variety of different electronic devices, mobile devices, transmitting devices, environments, position fix modes, etc.

According to an embodiment, method, at a mobile device, comprises: determining an expected measurement drift rate for measurements obtained from a barometric pressure sensor of the mobile device; and determining a duration between consecutive operations to calibrate the barometric pressure sensor while the mobile device is located in a building based, at least in part, on the expected measurement drift rate and an expected difference in altitude between discrete vertical levels of the building. In one alternative implementation, the method further comprises periodically performing an operation to calibrate the barometric pressure sensor based on the duration. In another particular implementation, the duration comprises a maximum duration between consecutive calibration operations. In another particular implementation, the method further comprises: obtaining a barometric pressure measurement from a barometric pressure sensor on the mobile device; correlating the barometric pressure measurement with an altitude of a particular one of the discrete vertical levels; and calibrating the barometric pressure sensor based, at least in part, on the altitude of the particular discrete vertical level correlated with the barometric pressure measurement. In another particular implementation, correlating the barometric pressure measurement with an altitude of a particular one of the discrete vertical levels comprises: determining that an altitude based on the barometric pressure measurement is closest to the altitude of the particular discrete vertical level from among altitude of the discrete vertical levels. In another particular implementation, the method further comprises obtaining an initial calibration of the barometric pressure sensor by: determining that the mobile device is on a particular floor of the building, wherein the floor is at a known altitude; and calibrating the barometric pressure sensor while the mobile device is located on the floor. In another particular implementation, the method further comprises performing a subsequent calibration of the barometric sensor by: obtaining the altitude of the particular discrete vertical level based, at least in part, on the known altitude of the floor and an offset; and calibrating the barometric pressure sensor based, at least in part, on the altitude of the particular vertical level, the obtained barometric pressure measurement, a reference pressure value and an altitude corresponding to the reference pressure value. In another particular implementation, the method further comprises determining known altitude based, at least in part, on an SPS position fix prior to entering the floor.

In another embodiment, a mobile device comprises: a barometric pressure sensor; and one or more processors configured to: determine an expected measurement drift rate for measurements obtained from the barometric pressure sensor; and determine a duration between consecutive operations to calibrate the barometric pressure sensor while the mobile device is located in a building based, at least in part, on the expected measurement drift rate and an expected difference in altitude between discrete vertical levels of the building. In a particular implementation, the one or more processors are further configured to periodically perform an operation to calibrate the barometric pressure sensor based on the duration. In another particular implementation, the duration comprises a maximum duration between consecutive calibration operations. In another particular implementation, the one or more processors are further configured to: obtain a barometric pressure measurement from a barometric pressure sensor on the mobile device; correlate the barometric pressure measurement with an altitude of a particular one of the discrete vertical levels; and calibrate the barometric pressure sensor based, at least in part, on the altitude of the particular discrete vertical level correlated with the barometric pressure measurement. In another particular implementation, the one or more processors are further configured to correlate the barometric pressure measurement with an altitude of a particular one of the discrete vertical levels by: determining that an altitude based on the barometric pressure measurement is closest to the altitude of the particular discrete vertical level from among altitude of the discrete vertical levels. In another particular implementation, the one or more processors are further configured to obtain an initial calibration of the barometric pressure sensor by: determining that the mobile device is on a particular floor of the building, wherein the floor is at a known altitude; and calibrating the barometric pressure sensor while the mobile device is located on the floor. In another particular implementation, the one or more processors are further configured to perform a subsequent calibration of the barometric sensor by: obtaining the altitude of the particular discrete vertical level based, at least in part, on the known altitude of the floor and an offset; and calibrating the barometric pressure sensor based, at least in part, on the altitude of the particular vertical level, the obtained barometric pressure measurement, a reference pressure value and an altitude corresponding to the reference pressure value. In another particular implementation, the one or more processors are further configured to determine the known altitude based, at least in part, on an SPS position fix prior to entering the floor.

In another embodiment, a non-transitory storage medium comprises machine-readable instructions stored thereon which are executable by one or more processors of a mobile device to: determine an expected measurement drift rate for measurements obtained from a barometric pressure sensor on-board the mobile device; and determine a duration between consecutive operations to calibrate the barometric pressure sensor while the mobile device is located in a building based, at least in part, on the expected measurement drift rate and an expected difference in altitude between discrete vertical levels of the building. In one particular implementation, the instructions are further executable by the one or more processors to periodically perform an operation to calibrate the barometric pressure sensor based on the duration. In another particular implementation, the duration comprises a maximum duration between consecutive calibration operations. In another particular implementation, the instructions are further executable to obtain a barometric pressure measurement from a barometric pressure sensor on the mobile device; correlate the barometric pressure measurement with an altitude of a particular one of the discrete vertical levels; and calibrate the barometric pressure sensor based, at least in part, on the altitude of the particular discrete vertical level correlated with the barometric pressure measurement. In another particular implementation, the instructions are further executable by the one or more processors to correlate the barometric pressure measurement with an altitude of a particular one of the discrete vertical levels by: determining that an altitude based on the barometric pressure measurement is closest to the altitude of the particular discrete vertical level from among altitude of the discrete vertical levels. In another particular implementation, the instructions are further executable by the one or more processors to obtain an initial calibration of the barometric pressure sensor by: determining that the mobile device is on a particular floor of the building, wherein the floor is at a known altitude; and calibrating the barometric pressure sensor while the mobile device is located on the floor. In another particular implementation, the instructions are further executable by the one or more processors to perform a subsequent calibration of the barometric sensor by: obtaining the altitude of the particular discrete vertical level based, at least in part, on the known altitude of the floor and an offset; and calibrating the barometric pressure sensor based, at least in part, on the altitude of the particular vertical level, the obtained barometric pressure measurement, a reference pressure value and an altitude corresponding to the reference pressure value. In another particular implementation, the instructions are further executable by the one or more processors to determine the known altitude based, at least in part, on an SPS position fix prior to entering the floor.

In another embodiment, a mobile device comprises: means for determining an expected measurement drift rate for measurements obtained from a barometric pressure sensor of the mobile device; and means for determining a duration between consecutive operations to calibrate the barometric pressure sensor while the mobile device is located in a building based, at least in part, on the expected measurement drift rate and an expected difference in altitude between discrete vertical levels of the building. In a particular alternative implementation, the mobile device further comprises means for periodically performing an operation to calibrate the barometric pressure sensor based on the duration. In another alternative implementation, the duration comprises a maximum duration between consecutive calibration operations. In another particular implementation, the mobile device further comprises means for obtaining a barometric pressure measurement from a barometric pressure sensor on the mobile device; means for correlating the barometric pressure measurement with an altitude of a particular one of the discrete vertical levels; and means for calibrating the barometric pressure sensor based, at least in part, on the altitude of the particular discrete vertical level correlated with the barometric pressure measurement. In another alternative implementation, the means for correlating the barometric pressure measurement with an altitude of a particular one of the discrete vertical levels comprises: means for determining that an altitude based on the barometric pressure measurement is closest to the altitude of the particular discrete vertical level from among altitude of the discrete vertical levels. In another particular implementation, the means for obtaining an initial calibration of the barometric pressure sensor further comprises: means for determining that the mobile device is on a particular floor of the building, wherein the floor is at a known altitude; and means for calibrating the barometric pressure sensor while the mobile device is located on the floor. In another particular implementation, the means for performing a subsequent calibration of the barometric sensor further comprises: means for obtaining the altitude of the particular discrete vertical level based, at least in part, on the known altitude of the floor and an offset; and means for calibrating the barometric pressure sensor based, at least in part, on the altitude of the particular vertical level, the obtained barometric pressure measurement, a reference pressure value and an altitude corresponding to the reference pressure value. In another alternative implementation, the mobile device further comprises means for determining the known altitude based, at least in part, on an SPS position fix prior to entering the floor.

In another embodiment, a mobile device comprises means for determining that the mobile device is located at a frequently visited location and that an onboard barometric pressure sensor is in a calibrated state; means for determining that said mobile device is further located on a particular discrete vertical level of a plurality of discrete vertical levels at said frequently visited location; means for determining an altitude value based, at least in part, one or more signals from said onboard barometric pressure sensor; and means for storing said determined altitude value in association with said particular vertical level. In one alternative implementation, the mobile device further comprises means for determining that the onboard barometric pressure sensor is in a calibrated state further comprises determining whether an expected error or uncertainty in one or more calibration parameters is less than a threshold value. In another particular implementation, the means for determining that the mobile device is located at a frequently visited location further comprises means for associating an approximate horizontal location of the mobile device with a location defined in map. In another particular implementation, the frequently visited location comprises a building and at least two of the plurality of discrete vertical levels comprise floors of the building. In another particular implementation, the means for determining the altitude value further comprises: means for obtaining one or more barometric pressure measurements from the onboard barometric pressure sensor; and means for applying a previously determined calibration parameter to the one or more barometric pressure measurements to determine the altitude value. In another particular implementation, the means for determining that the mobile device is located on the particular discrete vertical level further comprises: means for determining that mobile device is located in on the particular discrete vertical level based, at least in part, on measurements obtained from a wireless receiver device, one or more signals generated via a user interface or measurements obtained from one more inertial sensors, or any combination thereof. In another alternative implementation, the mobile device further comprises: means for obtaining an estimated location based, at least in part, on an acquisition of satellite positioning system (SPS) signals; and means for placing the barometric pressure sensor in the calibrated state based, at least in part, on an altitude component of the estimated location and a barometric pressure measurement obtained contemporaneous with the acquisition of the SPS signals. In another particular implementation, the mobile device further comprises means for determining that the mobile device is located at the frequently visited location based, at least in part, on a user input received via a user interface of the mobile device.

In another embodiment, a non-transitory storage medium comprises computer-readable instructions stored thereon which are executable by a processing unit of a mobile device to: determine that the mobile device is located at a frequently visited location and that an onboard barometric pressure sensor is in a calibrated state; determine that said mobile device is further located on a particular discrete vertical level of a plurality of discrete vertical levels at said frequently visited location; determine an altitude value based, at least in part, one or more signals from said onboard barometric pressure sensor; and store said determined altitude value in a memory device in association with said particular vertical level. In an alternative implementation, the instructions are further executable by the processing unit to determine that the onboard barometric pressure sensor is in a calibrated state further by determining whether an expected error or uncertainty in one or more calibration parameters is less than a threshold value. In another alternative implementation, the instructions are further executable by the processing unit to determine that the mobile device is located at a frequently visited location by associating an approximate horizontal location of the mobile device with a location defined in a map. In another alternative implementation, the frequently visited location comprises a building and at least two of the plurality of discrete vertical levels comprise floors of the building. In another particular implementation, the instructions are further executable by the processing unit to determine the altitude value by: obtaining one or more barometric pressure measurements from the onboard barometric pressure sensor; and applying a previously determined calibration parameter to the one or more barometric pressure measurements to determine the altitude value. In another alternative implementation, the instructions are further executable by the processing unit to determine that the mobile device is located on the particular discrete vertical level by: determining that the mobile device is located in on the particular discrete vertical level based, at least in part, on measurements obtained from a wireless receiver device, one or more input signals generated by a user interface or measurements obtained from one more inertial sensors, or any combination thereof. In another alternative implementation, the instructions are further executable by the processing unit to: obtain an estimated location based, at least in part, on an acquisition of satellite positioning system (SPS) signals; and place the barometric pressure sensor in the calibrated state based, at least in part, on an altitude component of the estimated location and a barometric pressure measurement obtained contemporaneous with the acquisition of the SPS signals. In another alternative implementation, the instructions are further executable by the processing unit to determine that the mobile device is located at the frequently visited location based, at least in part, on a user input signal received from a user interface of the mobile device.

In another embodiment, a mobile device comprises means for determining that the mobile device is located on a discrete vertical level at a frequently visited location; means for obtaining one or more barometric pressure measurements from an onboard barometric pressure sensor; means for selecting a discrete level from among a plurality of discrete vertical levels identified in a memory device based at least in part on the obtained one or more barometric pressure measurements; and means for aligning the obtained one or more barometric pressure measurements with an altitude value stored in the memory device corresponding to the selected discrete vertical level to calibrate the onboard barometric pressure sensor. In an alternative implementation, the means for determining that the mobile device is located at a frequently visited location further comprises means for associating an approximate (potentially horizontal) location of the mobile device with a location defined in a map (e.g., in a structure represented in the map, etc.). In another alternative implementation, the frequently visited location comprises a building and at least two of the plurality of discrete vertical levels comprise floors of the building. In another alternative implementation, the mobile device further comprises means for determining that the mobile device is located at the frequently visited location based, at least in part, on an association of an approximate location of the mobile device with a location of the building defined in a map. In another alternative implementation, the mobile device further comprises means for determining that the mobile device is located on the discrete vertical level based, at least in part, on measurements obtained from a wireless receiver device, one or more signals generated by a user interface or measurements obtained from one more inertial sensors, or any combination thereof. In another alternative implementation, the memory device stores altitude values corresponding with the discrete vertical levels, and wherein the means for selecting the discrete vertical level from among the plurality of discrete vertical levels further comprises: means for mapping the one or more barometric pressure measurements to an estimated altitude; and means for comparing the estimated altitude with the altitude values corresponding with the discrete vertical levels to determine the altitude value most closely matching the obtained one or more barometric pressure measurements. In another alternative implementation, the mobile device further comprises means for computing a drift parameter for application to future barometric pressure measurements obtained from the barometric pressure sensor based, at least in part, on the one or more barometric pressure measurements and an altitude value stored in the memory device corresponding to the selected discrete vertical level.

In another embodiment, a non-transitory storage medium comprises computer-readable instructions stored thereon which are executable by a processing unit of a mobile device to: determine that the mobile device is located on a discrete vertical level at a frequently visited location; obtain one or more barometric pressure measurements from an onboard barometric pressure sensor; select a discrete level from among a plurality of discrete vertical levels identified in a memory device based at least in part on the obtained one or more barometric pressure measurements; and align the obtained one or more barometric pressure measurements with an altitude value stored in the memory device corresponding to the selected discrete vertical level to calibrate the onboard barometric pressure sensor. In one particular implementation, the instructions are further executable by the processing unit to determine that the mobile device is located at a frequently visited location by associating an approximate horizontal location of the mobile device with a location defined in a map. In another particular implementation, the frequently visited location comprises a building and at least two of the plurality of discrete vertical levels comprise floors of the building. In another alternative implementation, the instructions are further executable by the processing unit to determine that the mobile device is located at the frequently visited location based, at least in part, on an association of an approximate location of the mobile device with a location of the building defined in a map. In another alternative implementation, the instructions are further executable by the processing unit to determine that the mobile device is located on the discrete vertical level based, at least in part, on measurements obtained from a wireless receiver device, one or more signals generated by a user interface or measurements obtained from one more inertial sensors, or any combination thereof. In another alternative implementation, the memory device stores altitude values corresponding with the discrete vertical levels, and the instructions are further executable by the processing unit to select the discrete vertical level from among the plurality of discrete vertical levels by: mapping the one or more barometric pressure measurements to an estimated altitude; and comparing the estimated altitude with the altitude values corresponding with the discrete vertical levels to determine the altitude value most closely matching the obtained one or more barometric pressure measurements. In another alternative implementation, the instructions are further executable by the processing unit to compute a drift parameter for application to future barometric pressure measurements obtained from the barometric pressure sensor based, at least in part, on the one or more barometric pressure measurements and an altitude value stored in the memory device corresponding to the selected discrete vertical level.

The techniques described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically motion stated otherwise, as apparent from the following discussion, it is appreciated that throughout this specification discussions utilizing terms such as “processing”, “computing”, “calculating”, “determining”, “generating”, “obtaining”, “modifying”, “selecting”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method, at a mobile device, comprising:
determining that the mobile device is located at a frequently visited location and that an onboard barometric pressure sensor is in a calibrated state;
determining that the mobile device is located on a particular discrete vertical level of a plurality of discrete vertical levels at the frequently visited location;
determining an altitude value based, at least in part, one or more signals from the onboard barometric pressure sensor; and
storing the determined altitude value in association with the particular discrete vertical level, the frequently visited location, or both.

2. The method of claim 1, wherein determining that the onboard barometric pressure sensor is in the calibrated state further comprises determining whether an expected error or uncertainty in one or more calibration parameters is less than a threshold value.

3. The method of claim 1, wherein determining that the mobile device is located at the frequently visited location further comprises associating an approximate location of the mobile device with a location defined in a map.

4. The method of claim 1, wherein determining that the mobile device is located at the frequently visited location further comprises:
detecting wireless signals;
comparing the detected wireless signals to previously saved wireless signals;
determining that the detected signals correspond to signals previously detected at the frequently visited location.

5. The method of claim 1, wherein determining the altitude value further comprises:
obtaining one or more barometric pressure measurements from the onboard barometric pressure sensor; and
applying a previously determined calibration parameter to the one or more barometric pressure measurements to determine the altitude value.

6. The method of claim 1, wherein determining that the mobile device is located on the frequently visited location further comprises:
determining that the mobile device is located in on the particular discrete vertical level based, at least in part, on measurements obtained from a wireless receiver device, one or more input signals generated by a user interface or measurements obtained from one more inertial sensors, or any combination thereof.

7. The method of claim 1, and further comprising:
obtaining an estimated location based, at least in part, on an acquisition of satellite positioning system (SPS) signals; and
placing the onboard barometric pressure sensor in the calibrated state based, at least in part, on an altitude component of the estimated location and a barometric pressure measurement obtained contemporaneous with the acquisition of SPS signals.

8. The method of claim 1, and further comprising determining that the mobile device is located at the frequently visited location based, at least in part, on an input received via a user interface of the mobile device.

9. A mobile device comprising:
an onboard barometric pressure sensor;
a memory device; and
a processing unit configured to:
determine that the mobile device is located at a frequently visited location and that the onboard barometric pressure sensor is in a calibrated state;
determine that the mobile device is located on a particular discrete vertical level of a plurality of discrete vertical levels at the frequently visited location;
determine an altitude value based, at least in part, one or more signals from the onboard barometric pressure sensor; and
store the determined altitude value in the memory device in association with the particular discrete vertical level, the frequently visited location, or both.

10. The mobile device of claim 9, wherein determining that the onboard barometric pressure sensor is in the calibrated state further comprises determining whether an expected error or uncertainty in one or more calibration parameters is less than a threshold value.

11. The mobile device of claim 9, wherein the processing unit is further configured to determine that the mobile device is located at the frequently visited location by associating an approximate horizontal location of the mobile device with a location defined in a map.

12. The mobile device of claim 9, wherein the frequently visited location comprises a building and at least two of the plurality of discrete vertical levels comprise floors of the building.

13. The mobile device of claim 9, wherein the processing unit is further configured to:
obtain one or more barometric pressure measurements from the onboard barometric pressure sensor; and
apply a previously determined calibration parameter to the one or more barometric pressure measurements to determine the altitude value.

14. The mobile device of claim 9, wherein the processing unit is further configured to:
determine that mobile device is located in on the particular discrete vertical level based, at least in part, on measurements obtained from a wireless receiver device, one or more signals generated by a user interface or measurements obtained from one more inertial sensors, or any combination thereof.

15. The mobile device of claim 9, wherein the processing unit is further configured to:
obtain an estimated location based, at least in part, on an acquisition of satellite positioning system (SPS) signals; and
place the onboard barometric pressure sensor in the calibrated state based, at least in part, on an altitude component of the estimated location and a barometric pressure measurement obtained contemporaneous with the acquisition of SPS signals.

16. The mobile device of claim 9, wherein the processing unit is further configured to determine that the mobile device isolated at the frequently visited location based, at least in part, on an input received via a user interface of the mobile device.

17. A method at a mobile device comprising:
determining that the mobile device is located on a discrete vertical level at a frequently visited location;
obtaining one or more barometric pressure measurements from an onboard barometric pressure sensor;
selecting a discrete level from among a plurality of discrete vertical levels identified in a memory device based at least in part on the obtained one or more barometric pressure measurements; and
aligning the obtained one or more barometric pressure measurements with an altitude value stored in the memory device corresponding to the selected discrete vertical level to calibrate the onboard barometric pressure sensor.

18. The method of claim 17, wherein determining that the mobile device is located at the frequently visited location and further comprising associating an approximate horizontal location of the mobile device with a location defined in a map.

19. The method of claim 17, wherein the frequently visited location comprises a building and at least two of the plurality of discrete vertical levels comprise floors of the building.

20. The method of claim 19, and further comprising determining that the mobile device is located at the frequently visited location based, at least in part, on an association of an approximate location of the mobile device with a location of the building defined in a map.

21. The method of claim 17, and further comprising determining that the mobile device is located on the discrete vertical level based, at least in part, on measurements obtained from a wireless receiver device, one or more signals generated by a user interface or measurements obtained from one more inertial sensors, or any combination thereof.

22. The method of claim 17, wherein the memory device stores altitude values corresponding with the plurality of discrete vertical levels, and wherein selecting the discrete vertical level from among the plurality of discrete vertical levels further comprises:
mapping the one or more barometric pressure measurements to an estimated altitude; and
comparing the estimated altitude with the altitude values corresponding with the plurality of discrete vertical levels to determine the altitude value most closely matching the obtained one or more barometric pressure measurements.

23. The method of claim 17, and further comprising computing a drift parameter for application to future barometric pressure measurements obtained from the onboard barometric pressure sensor based, at least in part, on the one or more barometric pressure measurements and the altitude value stored in the memory device corresponding to the selected discrete vertical level.

24. A mobile device comprising:
an onboard barometric pressure sensor
a memory device; and
a processing unit configured to:
determine that the mobile device is located on a discrete vertical level at a frequently visited location;
obtain one or more barometric pressure measurements from the onboard barometric pressure sensor;
select a discrete level from among a plurality of discrete vertical levels identified in the memory device based at least in part on the obtained one or more barometric pressure measurements; and
align the obtained one or more barometric pressure measurements with an altitude value stored in the memory device corresponding to the selected discrete vertical level to calibrate the onboard barometric pressure sensor.

25. The mobile device of claim 24, wherein the processing unit is further configured to determine that the mobile device is located at the frequently visited location by associating an approximate horizontal location of the mobile device with a location defined in a map.

26. The mobile device of claim 24, wherein the frequently visited location comprises a building and at least two of the plurality of discrete vertical levels comprise floors of the building.

27. The mobile device of claim 26, wherein the processing unit is further configured to determine that the mobile device is located at the frequently visited location based, at least in part, on an association of an approximate location of the mobile device with a location of the building defined in a map.

28. The mobile device of claim 24, wherein the processing unit is further configured to determine that the mobile device is located on the discrete vertical level based, at least in part, on measurements obtained from a wireless receiver device, one or more signals generated by a user interface or measurements obtained from one more inertial sensors, or any combination thereof.

29. The mobile device of claim 24, wherein the memory device stores altitude values corresponding with the plurality of discrete vertical levels, and wherein the processing unit is further configured to:
map the one or more barometric pressure measurements to an estimated altitude; and
compare the estimated altitude with the altitude values corresponding with the plurality of discrete vertical levels to determine the altitude value most closely matching the obtained one or more barometric pressure measurements.

30. The mobile device of claim 24, wherein the processing unit is further configured to compute a drift parameter for application to future barometric pressure measurements obtained from the onboard barometric pressure sensor based, at least in part, on the one or more barometric pressure measurements and the altitude value stored in the memory device corresponding to the selected discrete vertical level.
